(19) United States
(12) Patent Application Publication
(10) Pub. No.: US 2010/0044173 A1
(43) Pub. Date: Feb. 25, 2010

(54) SELF-ADJUSTABLE SHOCK ABSORBER, WITH SELF-CORRECTING DAMPING CHARACTERISTIC, HAVING CURVED, CYLINDRICAL AND PLANAR FILLING VALVES

(76) Inventor: Adiran loan Niculescu, Bucharest (RO)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/445,072

(22) PCT Filed: Oct. 8, 2007
(86) PCT No.: PCT/RO07/00019

§ 371 Date: Apr. 9, 2009

(30) Foreign Application Priority Data
Oct. 10, 2006 (RO) A 206 00770

(51) Int. Cl. F16F 9/32

(52) U.S. Cl. 188/313

(57) ABSTRACT

Automotive self-adjustable shock absorber with self-correcting damping characteristic, having curved, cylindrical and planar filling valves has single or double guide, seal by removable joint (57), or seal member (11) applied on the outer lid (52), rebound stopper bumper QO) with limiting casing (21), on the piston (4), or stopper bumper (20) in cup hanger (22), fastened on the piston rod (V), through the safety ring (61). It filling on compression with the inner curved, cylindrical (32), planar valves, placed directly in the inner cylinder, or on simple or cast inner annular body inside inner cylinder, or on simple outer valves or using outer valves with cast annular body, placed on the upper side of the inner cylinder (V). It filling on rebound with the inner curved, cylindrical (30), planar valves, placed directly in the inner cylinder, or on simple or cast inner annular body inside inner cylinder, or on simple outer valves or using outer valves with cast annular body, placed on the lower side of the inner cylinder (V). The fastening/aligning of the inner cylinder (V), against the outer cylinder (6), is made on the upper side through the annular lid Q), or with longitudinal indentation, or with annular collar. The fastening/alignment of the inner cylinder (1), to the outer cylinder (6), is made on the lower side through the collar (n″″″\ or with fastening hub.

### CROSS REFERENCE TO RELATED APPLICATION

This application claims priority from PCT Application No. PCT/R02007/000019, filed 8 Oct. 2007, which claims priority to Romanian Application a 2006 00770, filed 10 Oct. 2006, the entire specification and drawings of which are hereby incorporated by reference.

### BACKGROUND OF THE INVENTION

The invention refers to an automotive self-adjustable shock absorber with self-correcting damping characteristic, filled with curved, cylindrical and planar filling valves, having according to the preamble of claim 1

The self-adjustable shock absorber with self-correcting damping characteristic, filling with curved, cylindrical and planar filling valves, has a progressive damping characteristic, used at vehicles and auto vehicles for wheels, body, chassis, driver and passenger seats, engine group oscillations damping, like in shock bumpers, for impact energy absorption. Depending on the situation it can be used unpressurized, at low pressure for improving the damping characteristic or pressurized at a high pressure for assuring a buoyant force too.

At high pressure it can be used like a stabilizer for the bonnets and door, both for vehicles and motor vehicles

Unpressurized, or medium or high pressurized, it can be used like a stabilizer or tail gate thrust, in aeronautic or naval industry, military technique, for civil and industrial construction, furniture or different sportive and household articles, inclusive like an anti earthquake stabilizer.

Their components can be derived from classic shock absorber/damper, but specific solutions cheaper and more performing and compact are preferable.

The patents RO 1185546 and EP 1 119 184 show the principles and sketches for divers self-adjustable shock absorbers with self-correcting damping characteristics, unrevealed solutions for filling valves, for precisely stroke limit at rebound, which due to the new conception is specific, solution for elements (inner cylinder, guide, or guides in cases of twin guides, seal element) aligning.

The problem underlying the invention is to provide by technological simple and reliable means for filling valves, for precisely stroke limit at rebound, for a better element aligning, and for reducing the elements number.

These problems are solved with reliable, compact and cheap solutions, comprising the features of claim 1. Preferred embodiments are claimed in claims 2 to 25.

The shock absorber according to the invention assures an efficient filling on rebound and compression, made by cylindrical filling valves placed inside inner cylinder, at its ends, and solid with this.

The filling valves can be placed the same to the inner annular bodies inside the inner cylinder or on annular cover outside inner cylinder, sealed with the inner cylinder and communicating with this through one or more holes in the inner cylinder, the valves section being curve, with convenient profile, inclusive cylindrical or planar.

The solution eliminates valve body and the holding cup of the upper filling valve, assuring compact and cheap solution.

Due to the valve body eliminating, the axial limitation and centering are assumed by the lower part of the inner cylinder, machined in

For a better fastening and seal, the contact area on the inner cylinder and/or the bottom lid of the tank cylinder is plated with malleable material.

At the solutions that the shock absorber must limits precisely the rebound stroke, round the rod, on the piston, or on the shoulder fasten on the rod, a rigid, semi rigid, or elastic stopper bumper placed, the stopper bumpers being muffed with a rigid/semi rigid restricted ring, at the solutions which the collision stopper bumper area coincide with the valves area.

The balancing chamber is delimitated on height by a cylinder with holes, placed on the inner lid, centered or not radial with the inner lid. For rigidity, simplicity, the inner cylinder is lengthened above the inner cylinder head, forming the balance chamber.

The liquid level in the balancing chamber is stabilized with tranquilizing elements fastened rigidly or elastically on the inner cylinder.

The balance chamber closing and axial fasten is made by in the upper part by a specific outer lid, containing a seal element for rod sealing, and an elastic cloak sealing the outer cylinder. An annular shoulder on the inferior face of the external lid centers the cylinder defining balance chamber

The piston fasten on the rod is made by nut or riveting. For gauge reasons the fasten element e.g. the nut or riveting are buried.

For material economy and relief the piston is empty inside.

For technological and functional reasons the metering holes/slots sideways inner cylinder is/are realized in one or more steps.

According to the invention the shock absorbers has/have the next advantages:

the curved/cylindrical filling valves, fasten directly on the inner cylinder, eliminating the valve body and the protector holder of the upper valve, a solution simple, compact and cheap solution;

placing of the curved/cylindrical/planar filling valves on bodies on the outer side of the inner cylinder shorten the length and permit its placements along all inner cylinder, favoring the filling

adding a rebound stopper bumper, the precisely stroke limiting is assured

inner cylinder lengthened above the inner cylinder head for balance chamber forming, reduces costs and increases robustness

oil tranquillers placed on the balancing chamber fastening by forms, elastic or rigid, permit cheap solutions

the outer lid assures both the fastening of the cylinder forming balance chamber or inner cylinder fasten (when the balance chamber is made elongating the inner cylinder) and the sealing between the outer cylinder and rod, simple and cheap solution;

the solution with seal element fastened in the upper inner cylinder part, with the upper inner cylinder centered by outer cylinder shoulder, assuring, simplicity, robustness and cheaper solution;

for a better sealing the piston is equipped with more segments

for size and costs reducing the piston on rod fastening is made by riveting, better buried, and for material economy and weight reducing, the piston is empty inside;

the solutions of the inner valves, outer lid and aligning assures a shock absorber with performances closes by semi-intelligent suspension at similar prices similarly or reduces relative to the standard shock absorbers

### BRIEF DESCRIPTION OF THE DRAWINGS

We give 24 examples of achieving the invention in 86 variants referring to FIGS. 1 . . . 89 representing:

FIG. 1: the assembly drawing for the solution with curved/cylindrical inner and external filling valves, with labyrinth system un centered relative the guide and independent to the inner cylinder, fastening hub, according to the first accomplishing example;

FIG. 2: A detail, for outer cylinder closing-sealing area with the external lid;

FIG. 3: B detail, for the road slidably sealing

FIG. 4: C detail, disk soldered/pressed on cylinder, forming labyrinth

FIG. 5: D detail, for disks or disks assembly forming labyrinth system, fastening by shape

FIG. 6: E detail, for axial guide limitation

FIG. 7: F detail, for rebound stopper bumper fastening in the inner trough of the limiting casing

FIG. 8: G detail, for rebound stopper bumper fastened in limiting casing holes and filling valve fasten nut on the planished surface on the outer face of inner cylinder

FIG. 9: H-H transverse section in hollow piston/with inner cuttings

FIG. 10: 1-I longitudinal section, in hollow piston/with inner cuttings

FIG. 11: J side view of large segment

FIG. 12: J side view of narrow segment

FIG. 13: K-K section, showing location and fastening for one or more inner filling valve with one or two overlap curved/cylindrical plates:

T view: directly on the inner surface of the inner cylinder;

U view: on the inner surface of the inner cylinder, remaining prominent after machine/erode of the neighbor surfaces;

—V view: on curved/cylindrical prominences resulting from material added on the inner surface of the inner cylinder

FIG. 14: L detail—plate valve fastening with rivet having profiled head

FIG. 15: L detail—fastening variant with rivet having profiled head

FIG. 16: M detail—longitudinal section in external filling valve, the filling orifices area

FIG. 17: N detail—longitudinal section in external filling valve, the fastening area

FIG. 18: 0-0 transverse section, in external filling valve, with plates on:

in T view: directly on the inner surface of the annular cover;

in U view: on the inner surface of the annular cover, remaining prominent after machine/erode of the neighbor surfaces;

in V view: on curved/cylindrical prominences resulting from material added on the inner surface of the annular cover

FIG. 19: P detail—variant for plate valve fastening with screw with buried head, nut and setting hub on plate and annular cover/inner cylinder

FIG. 20: Q-Q longitudinal section, showing the plates dispose on a prominence of malleable material

FIG. 21: R detail—longitudinal section showing the plate fastening on the external valve, with standard rivet and with setting hub on plate and annular cover, with sealing area realized by machining/eroding

FIG. 22: S detail—showing longitudinal section in sealing area, realized by material

adding FIG. 23: T view, showing on unroll view:

the plate for covering 2×3 filling orifices, with internal channels/slots and 2 fastening holes

the plates, filling orifices and fastening area, FIG. 24: U view, showing on unroll view:

the plate without internal channels/slots, with a circular fastening boring.

the plate, the setting area and circular boring for fastening element

FIG. 25: V view, showing on unroll view:

The plate with internal channels/slots, square fastening boring

The plate and setting areas, on the inner surface of the inner cylinder/annular cover/inner annular body/cast or injected annular body

FIG. 26: W view showing on unroll view:

The plate with internal channels, square fastening boring and simple or double tongue linked by connecting link

The plate and setting areas, on the inner surface of the inner cylinder/annular cover/inner annular body/cast or injected annular body

FIG. 27: X view showing on unroll view:

Profiled plate with internal channels, square fastening orifice and simple or double tongues linked by connecting link

The profiled plate and setting areas, on the inner surface of the inner cylinder/annular cover/inner annular body/cast or injected annular body

FIG. 28: Y-Y transverse section showing the plate in working position (shut) and simple or double tongues linked by connecting link

FIG. 29: Z view showing on unroll view:

The plate with 4 internal channels, square fastening boring and 4 simple tongue

The plate with internal channels, square fastening boring

The overlap plates and setting areas on the inner surface of the inner cylinder/annular cover/inner annular body/cast or injected annular body

FIG. 30: AA view showing on unroll view:

The plate with 4 internal channels, rotate square fastening boring and 2 simple tongue on the same axis, axis differing from the first plate axis (result rotating the first plate with)180°)

The overlap plates and setting areas, on the inner surface of the inner cylinder/annular cover/inner annular body/cast or injected annular body

FIG. 31: AB view showing on unroll view:

The plate with 4 internal channels, rotate square fastening boring and 2 simple tongue on the same side, the second plate rotated with 180° relative to the first

The overlap plates and setting areas, on the inner surface of the inner cylinder/annular cover/inner annular body/cast or injected annular body

FIG. 32: AC-AC transverse section showing in working situation (shut) the plates and tongues

FIG. 33: AD-AD longitudinal section, showing the annular body with metering holes/slots

overlap on the technological or wrong holes

FIG. 34: AE-AE section in internal/outer filling valve, with curved/cylindrical valve plates on the inner annular body inside the inner cylinder/annular cover:

in T view: setting directly on the internal surface of the annular body;

in U view: setting on the internal surfaces of the annular body, becoming prominent by neighborhood surface machine/eroding; in V view: setting on the curved/cylindrical prominences resulting with material added on the inner surface of the annular body

FIG. 35: AF detail for the transverse section in the plate on inner annular body, inside the inner cylinder/annular cover, fastened using rivet with profiled head

FIG. 36: AF detail—variant—for transverse section in plate on inner annular body, inside the inner cylinder/annular cover, fastened using rivet with buried head and setting hub on the plates

FIG. 37: AF detail-variant—for transverse section in plate on internal annular body, inside the inner cylinder/annular cover, fastened using screw with buried head and setting hub on the plates

FIG. 38: AG detail for transverse section in plate on internal annular body, inside the inner cylinder/annular cover, fastened using rivet with normal head and plates setting hub, riveted in the inner cylinder/annular cover.

FIG. 39: AH detail for transverse section in plate on internal annular body, inside the inner cylinder/annular cover, fastened using screw with spherical head, plates setting hub and nut on a planished surface on the inner cylinder/annular cover.

FIG. 40: showing the plates unrolled, for small diameters of inner cylinder situation

FIG. 41: showing in the working position (shut) a transverse section in the postponement arm relative to the fastening boring, placed in the inner cylinder/annular cover/annular body

FIG. 42: showing in working position (shut) a transverse section in the arm prolonged at the fastening boring

FIG. 43: showing in working position a transverse section in elastic plate and spring plate

FIG. 44: shows in transverse section the variant with rigid/semi rigid/elastic plate and spring plate

FIG. 45: shows the section AN-AN in plate guiding area

FIG. 46: shows the section AO-AO for rigid/semi rigid/elastic/plate, controlled by helicoidally spring

FIG. 47: shows the square section AP-AP in the plates fastening area

FIG. 48: shows transverse section AQ-AQ, at variants with elastic plate with own strengthened tongues and spring plate, in working position (open)

FIG. 49: shows transverse section AR-AR at variant with rigid/semi rigid/elastic/plate and spring plate in working position (open)

FIG. 50: shows details for removable sealing device in outer lid, and for fastening in inner cylinder variant

FIG. 51: longitudinal section in double guiding shock absorber

FIG. 52: longitudinal section in single and double guiding shock absorber with rebound stopper bumper

FIG. 53: rebound stopper bumper hanger fastening detail

FIG. 54: superior planar axial body valve detail

FIG. 55: longitudinal section in self correcting shock absorber with superior planar axial body valve using disk plate and helicoidally spring, inner inferior curved/cylindrical filling valve and rebound stopper bumper on piston with limiting casing/cup hanger

FIG. 56: lower view cup hanger with inner cuttings

FIG. 57: longitudinal section in cup hanger with inner cuttings

FIG. 58: top view valve cup hanger with inner cuttings

FIG. 59: bottom view cup hanger with slots

FIG. 60: longitudinal section in cup hanger with slots

FIG. 61: top view cup hanger with slots

FIG. 62: lower view cup hanger with outer cuttings

FIG. 63: longitudinal section in valve cup hanger with outer cuttings

FIG. 64: top view cup hanger with outer cuttings

FIG. 65: lower view cup hanger with outer cuttings and setting collar

FIG. 66: longitudinal section in cup hanger with outer cuttings and setting collar

FIG. 67: top view cup hanger with outer cuttings and setting collar

FIG. 68: unroll view spring disk with legs

FIG. 69: side view spring disk with legs

FIG. 70: top view valve body for lower planar filling valve

FIG. 71: unroll view valve disk plate with legs

FIG. 72: side view valve disk plate with legs

FIG. 73: longitudinal section in valve body with lower filling valve

FIG. 74: longitudinal section in self adjustable shock absorber with double/simple guide, filling on compression with planar upper valve with disk plate with legs and filling on rebound with curved/cylindrical inner valve placed on the cast/injected annular body

FIG. 75: longitudinal section in cup with legs (slots) and fastening collar

FIG. 76: longitudinal section in self-adjustable shock absorber with double/simple guide filling on compression with planar upper valve with disk acts with spring plate with legs, and filling on rebound with planar lower valve, with rebound stopper bumper on piston/annular hunger.

FIG. 77: longitudinal section in self-adjustable shock absorber with double guide, with sealing element in outer lid/removable seal, filling on compression with curved/cylindrical inner valve and with planar valve on rebound, with rebound stopper bumper in piston.

FIG. 78: longitudinal section in self-adjustable shock absorber with double/simple guide, with balance chamber cylinder centered by collar on the upper inner cylinder head, filling on compression with curved/cylindrical external valve, and filling on rebound with planar lower valve, with rebound stopper bumper on piston.

FIG. 79: longitudinal section in self-adjustable shock absorber with double/simple guide, with balance chamber cylinder centered by collar on the upper inner cylinder head, filling on compression with curved/cylindrical external valve, and filling on rebound with curved/cylindrical internal valve, with rebound stopper bumper on piston and lower inner cylinder head.

FIG. 80: longitudinal section in self-adjustable shock absorber with double/simple guide, with inner cylinder lengthened above the inner cylinder head, forming the balance chamber, filling on compression and rebound with curved/cylindrical external valve, with rebound stopper bumper on annular hunger, piston fastened inside with rod flange/rim, and inner cylinder fastening hub on the bottom outer lid.

FIG. 81: longitudinal section in self-adjustable shock absorber with double guide, with the seal element in the outer lid/removable seal, having inner cylinder lengthened above the inner cylinder head, forming the balance chamber, filling on compression with curved/cylindrical internal valve, filing on rebound with planar inferior valve, with rebound stopper bumper in piston, hollow piston fastened outside with rod flange/rim, and equipped with three segments.

FIG. 82: longitudinal section detail for inner cylinder head with inner cylinder fastening area.

FIG. 83: longitudinal section in self-adjustable shock absorber with double guide, with the seal element in the outer lid/removable seal, having inner cylinder lengthened above the inner cylinder head, forming the balance chamber, filling with curved/cylindrical internal valves, with rebound stopper bumper on piston equipped with limiting casing/rebound stopper bumper in cup hanger, inner cylinder setting on fastening hub placed on bottom outer lid.

FIG. 84: longitudinal section in self-adjustable shock absorber with single guide, with the seal element in the outer lid/removable seal in inner cylinder, having inner cylinder lengthened above the inner cylinder head, forming the balance chamber, filling with inner curved/cylindrical valves, with rebound stopper bumper on piston equipped with limiting casing/rebound stopper bumper in cup hanger, inner cylinder setting on bottom outer lid cutting.

FIG. 85: longitudinal section in self-adjustable shock absorber with single guide, with the removable seal member in inner cylinder, having inner cylinder lengthen forming balance chamber, filling on compression by planar valve with disk plate and helicoidally spring, filling on rebound by inner curved/cylindrical valves, with rebound stopper bumper on piston/hunger, inner cylinder setting in bottom outer lid cutting.

FIG. 86: transverse section in filling valve with planar plates placed on internal annular body inside the inner cylinder:

in T view: directly on internal surface of the inner annular body;

in U view: on internal surface of the inner annular body remained prominent by neighborhood surfaces machine/eroding;

in V view: on curved/cylindrical prominences made with material adding on the inner surfaces of the inner annular body

FIG. 87: transverse section in filling valve with planar plates placed on cast annular body inside the inner surface of the inner cylinder/inner surface of the annular cover, setting on:

in T view: directly on inner surfaces of the cast annular body;

in U view: on internal surface of the cast annular body remained prominent by neighborhood surfaces machine/eroding;

in V view: on curved/cylindrical prominences made with material adding on the inner surfaces of the cast annular body

FIG. 88: transverse section in filling valve with planar plates placed on inner annular arcs, setting on:

in T view: directly on inner surfaces of the inner annular arcs; in U view: on internal surface of the inner annular arcs remained prominent by neighborhood surfaces machine/eroding;

in V view: on curved/cylindrical prominences made with material adding on the inner surfaces of the inner annular arcs

FIG. 89: transverse section in curved/rigid/semi rigid/elastic filling valve with external plate spring, open and shut variants

### DETAILED DESCRIPTION OF THE PREFERRED EMBODIMENT

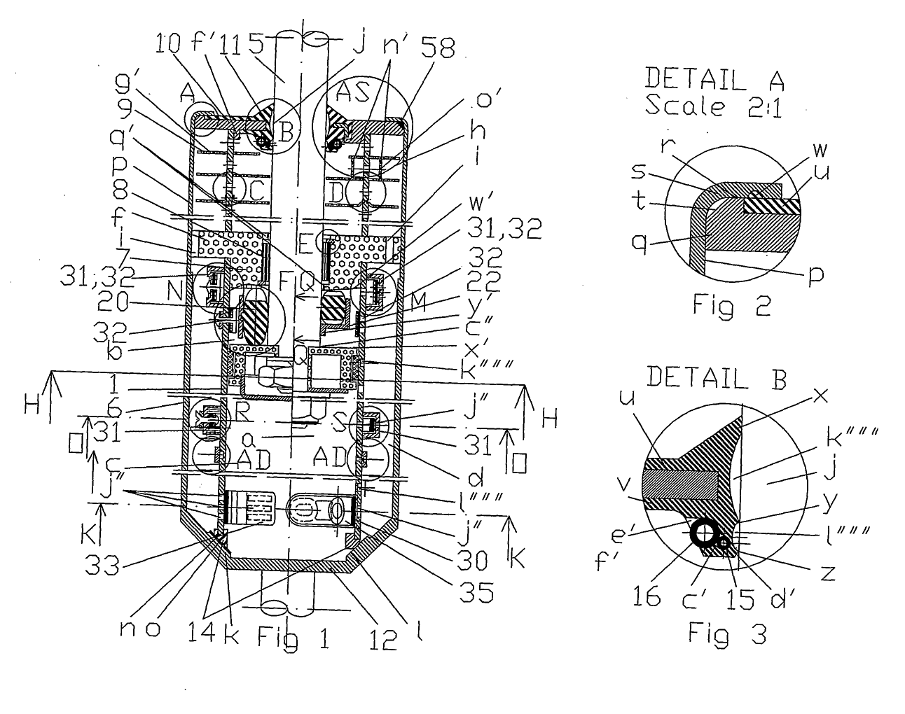

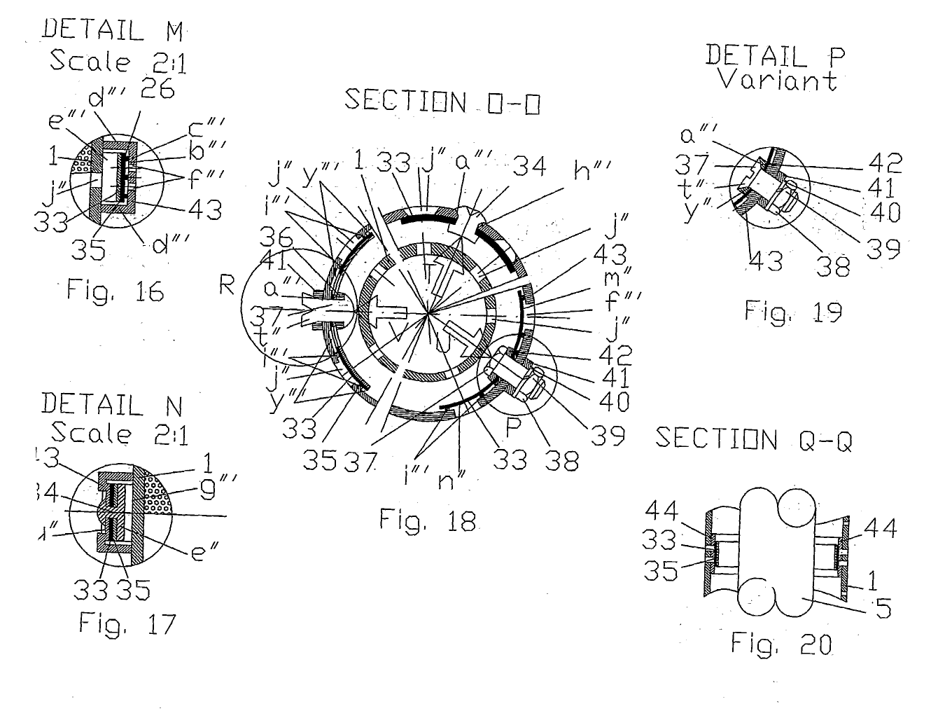

Automotive self-adjustable shock absorber with self-correcting damping characteristic, having curved, cylindrical and planar filling valve according to the first accomplishing example—FIG. 1-33, 81 presents the ensemble design, for the shock absorber solution with curved/cylindrical filling valve, rebound stopper bumper and discharged metering holes/slots.

An inner cylinder (1) forms a working chamber (a), the inner cylinder being provided along the length thereof with a plurality of rebound check metering holes/slots (JO and compression check metering holes/slots (V).

A piston (4) slidably mounted within the working chamber (a) and separating the working chamber (a) into a rebound compartment (b) and a compression compartment (c), the volumes of which vary in accordance with the position of the piston (4) in the working chamber (a).

A piston rod (5) connected to the piston (4) and extended for the end of the working chamber (a) adjacent to the rebound chamber (b) moves piston (4) inside the working chamber (a).

An outer cylinder (6) is disposed around the inner cylinder (Y), the space between both cylinders forming a reservoir chamber (d).

An inner cylinder head (T), of the inner cylinder (Y) close the end of the working chamber (a) adjacent the rebound compartment (b).

The inner cylinder head (T) is provided with an annular piston rod guide (8) or a central aperture (e), being sized to slidably engage around the piston rod (5) and with a collar φ rigid with the inner wall of the outer cylinder (6).

A labyrinth system (9) with passages (g) for working liquid passing, sustained on the upper part of the inner cylinder head (T), is upper limited by an outer upper lid (10), the compartment between the inner cylinder head (T), the outer upper lid (10), piston rod (5) and outer cylinder (6) forming a balance chamber (h).

A fluid fills the working chamber (a) and at least partially fills the balance chamber (h).

Some slots or holes (T) in collar (f) of the inner cylinder head (T) ensure the oil passing between the balance chamber (h) and reservoir chamber (d).

The outer upper lid (10) is provided with a seal member (11) having a center aperture (j) sized to slidably engage around the piston rod (5).

The outer cylinder (6) is closed in lower part with an bottom outer lid (12), having inside a prominence (k) whose face (l) is planed, conic, or spherical, machined, for inner cylinder (1) setting-centering using a fastening hub (14) made of metallic, plastic, elastic or elastic-plastic material, for better seal-centering.

The fastening hub (14) covering inside and/or outside the lower extremity of the inner cylinder (1), the fastening hub (14) having the inner faces (n) for the location of the inner cylinder (1) and the face (o) for its location on the prominence (k), with forms correlated with the forms of the mating members, its lower face (m) being processed in correlation with the face (Y) of the prominence (k).

In the upper area, the outer cylinder (6) has its inner surface processed on the area (g) for assuring the alignment with side (l) on the prominence (k) in its lower area. The outer upper lid (10) has its circular edge (g) firm with the outer cylinder (6) in the upper processed area (p_)5 being axially fixed through the side (r) to a closing flange (s) of the upper end of the outer cylinder (6). The closing flange (s) is allowed by the dull edge (t) in the outer upper lid (10). The sliding sealing member (U) of the piston rod (5) has two extensions, an upper one (u) and a lower one (v) which coat the outer upper lid (10) and they are secured to this. The outer upper lid (10) sealing is done as to the outer cylinder (6) by the upper extension (u) of the sliding sealing member (11) of the piston rod (5) which is preferable to have to its extremity a circular prominence (w) of a suitable cross section which deforms when the outer cylinder inflecting (s), assuring the contact pressure needed for sealing at high pressures. The prominence (w) is represented in a free state.

The opening (j) of the seal member (11) is endowed with three lips (x), (y), (z) limiting two chambers (k″″″) (T″″″). Behind the lower chamber Cl″″″) there is a circular trough (cl) where a ring spring (15) is inserted to increase the lips (y), (z) tightening power. The lower lip (z) gauging is made through a dull edge ((P). A second trough (§1) where a second ring spring (16) is inserted is provided for high pressures sealing. The trough (cl) or the troughs (cl), (V) position and the spring (15) forces, (15), (16) respectively is done function of the version so that one can obtain the desired tension distribution on the seal lips.

The outer upper lid (10) is provided at its lower edge with a centering circular tab (P), which poses radially the labyrinth system (9).

The labyrinth system (9) is made up of a cylinder (17) with holes (g) for the liquid passing and of some disks (18) provided with the communication holes (g). The disks (18) are fastened on the outer and/or inner side of the cylinder (17), either rigidly by pressing or welding or by molding. When attaching it by pressing, it should be provided with a collar (h) with some holes (T) or slots (\ddot{υ}) for favoring the molding. When molding it, on the cylinder (17) there are some troughs or hollows QO where one attaches elastically or by molding/pressing the prominences (T) of the disks (18). The prominences (F) of the disks (18) should be inclined in the preterminal part (ml)—For stiffing, in the case of several disks (18) these can be coupled two or several through connecting links (nl) provided with holes (ρl) for oil passing. For the axial limiting of the guide (8), the upper inner cylinder head (T) is provided in the trough (pl) with a tab (cjl) and a trough (O where an elastic ring is inserted (19). The tab (αj) can be placed either at the upper extremity or the lower one of the upper inner cylinder head (T), the position of the trough (rl) and of the ring (19) being correlated to the chosen version. For the firm limiting of the rebound stroke on the piston (4), around the piston rod (5), there is a rebound stopper bumper (20) which is coated in a rigid (metallic) limiting casing (21) when there are holes or valves in the rebound stopper area, defined by the inner part of the upper area of the inner cylinder (Y) and on the lower part of the upper inner cylinder head (T). The limiting casing (21) is less high than the stopper bumper (20) so that the stopper bumper (20) should come out of the either side of the limiting casing (21). The stopper bumper (20) should be conical or elliptical. The upper (sl) and lower (O sides of the stopper bumper (20) should be smooth or shaped according to the desired deformation characteristic. To maintain the relative position of the limiting casing (21), as to the stopper bumper (20), these are permanently or temporarily joined either by sticking the stopper bumper (20), in the limiting casing (21) or by the shape of the parts joined in the central part that is through a trough (ul) or several holes (V) in the limiting casing (21) penetrated by the bumper material (20). By a suitable choosing of materials and shapes, the limiting casing (21) can be cast together with the buffer (20) in one body.

In the case of a maximum rebound, the distance between the upper side of the piston (x!) and the lower side of the upper lid (w′) is big, the stopper bumper (20) is located on an annular hanger (60) or is introduced in a cup hanger (22) fastened on the piston rod (5), through a tab (y_!) or through an elastic ring (61), FIG. 52, FIG. 55, the bumper QO) height being bigger than the depth of the cup.

The upper lid and the piston should have attack sides of the bumper (w′), OO horizontal or conical, inclined from the upper side or the lower one, correlated to the desired deformation characteristic for the bumper (20) and the valve position for a better ventilation.

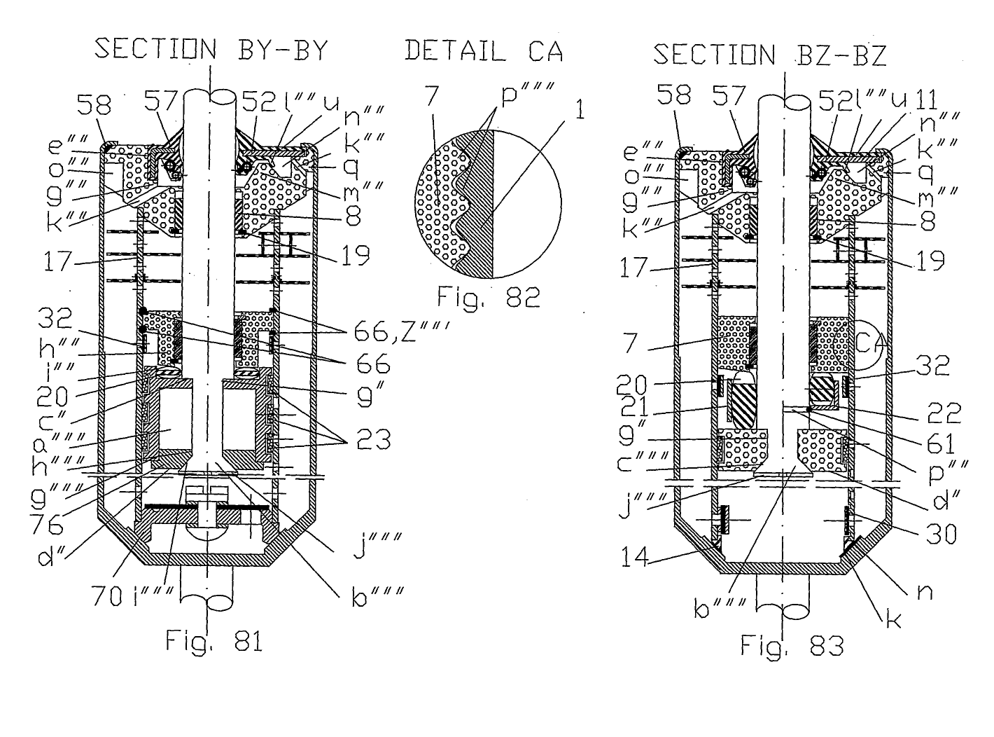

For improving the piston sealing (4) the cylinder area is provided with one or several troughs (z!) where one or several segments (23) are inserted, FIG. 81, which has a slot (§\ddot{υ}) cut in a zigzag with right edges for a better sealing. Function of the width and strength considerations, the segment (23) will have one (FIG. 12) or several steps (b\ddot{υ}) (FIG. 11).

The piston (4) on the piston rod (5) fastening is done axially in the upper area through a tab

(cf) of the rod (5) and in the lower part with an auto locking collared nut (24) on a flat washer (25) or with an a usual nut (26), a Grower washer (27) and a fiat washer (28), FIG. 10, applied directly on the inner side ((T) of the piston (4) or on a milling (e\ddot{υ}), provided on the lower side of the piston (4).

That is the reason why the lower end of the piston rod (5) is provided with a thread (£!). The radial fastening of the piston (4) on the piston rod (5) is achieved through a hole (ĝ) in the central part of the piston assuring its stiffness with the rod. For the reduction of the material consumption there is a cutting/recess (a″″″) or there are some cavities QgF) of a favorable shape inside the piston. When the attaching elements are buried in the piston, a tab (T!) in which a lid (29) is fixed is provided to prevent a gas blanket from appearing which should lead to an elastic behavior.

The filling on the rebound stroke is done through one or several inner rebound filling valves (30), placed right on the inner side (v\ddot{υ}) of the inner cylinder (Y), and/or through outer filling valves (31), all placed in the lower part of the inner cylinder Q).

The filling on the compression stroke is done through one or several inner compression filling valves (32) placed right on the inner side of the inner cylinder (1) and/or through the outer filling valve (31), all placed in the upper side of the inner cylinder (Y). For improving the filling, one can place along the inner cylinder (Y) several outer filling valves (31), these working at rebound when the piston (4) is above them and at compression, when the piston (4) is below them. Irrespective of the filling valve type, the working liquid access is done inside the inner cylinder (1) through holes/slots (Q provided in the inner cylinder (Y).

The inner rebound filling valves (30) and the compression fining valves (32) are made up of a curved/cylindrical plate (33), on the inner side of the inner cylinder (Y), the plate (33) being fixed with a rivet or screw (34), with profiled head, whose body passes through a boring QO provided in the wall of the inner cylinder (Y) and a boring (P) in the plate (33). For a better attachment and for avoiding the rotation one can use either several rivets or screws with profiled heads (34) placed on the generator of the inner cylinder (1) or in a normal plan on the radial cylinder axis or according to parallel axes, either rivets/screws or hubs which coat the rivet/screw, with a cross section different from the round one (square, rectangular or any other shape). In both cases the number and the shape of borings (k\ddot{υ}), (T) will be correlated with the number and shape of the fixing element (34). The plate can have one or two symmetrical arms (\ddot{ι}S″)>O-O5 or asymmetrical, whose ends cover the holes (Q provided in the inner cylinder. The access of the liquid from the reservoir chamber (d) inside the inner cylinder Q) is done due to the negative pressure in the inner cylinder (I) which, due to the power it generates on the arms (m″), (n̂) of the elastic plate (33) opens the holes O in me inner cylinder, allowing the liquid transfer.

The plate (33) can be strengthened with one or several additional identical or different elastic plates (35) provided on the inside, over the plate (33), for achieving the desired elastic characteristic and strength. The plate/plates (33)7(35) are fixed on the inner wall of the inner cylinder Q), either directly through the profiled head (ô) of the rivet/rivets or screw/screws with profiled head/s (34) when their placing side (χ£) on the plate has the width and the shape of the plates, either through the hub for the inner head (36), with the side (c£) to the plate profiled in connection to the width and the shape of the plate and with side (f̂), to the head QT) of the rivet/screw with planar head (37) correlated or not-hub (42), with their side (flat or conical). When the rivet/screw with planar head (37) is with a buried head, the boring (j£) will have the part (a′″) toward the head (fO* conically machined correlated to the head shape (£), of the rivet/screw (37)—FIG. 19. It is recommended that the width of the head (ĝ) of the rivet/screw with a profiled head (34) and of the hub (36) should be equal or bigger than the width of the plates the fix. A superior surface of the sides (£Q/(jO can assure a tighter tightening at ends. Outer the rivet (34)7(37) is fixed with an outer head (£). When using a screw, the outer fixing is done with a self-blocking nut (38) or a simple nut (39) and the Grower washer (40). The outer head (T) of the rivet (M)ZQT), the nut (38), the Grower washer (40) and the nut (39) can be placed directly on the inner cylinder (V). It is advisable that a milling (ι£) should be done in the cylinder (Y). For a good placing between the outer head (F) of the rivet or nut (38)/Grower washer (40) and nut (39) there is inserted a hub (41) which has the side (w″) in contact with the outer head of the rivet/screw (34)7(37) or with the nut (38)/Grower washer (40) and the flat nut (39) and the side QF) in contact with the inner cylinder (V), cylindrical with the diameter correlated to the inner cylinder (V). The borings (l\ddot{υ})/(z!0 provided in the hubs (36)/(41)/(42) for the passing of the rivet/screw body (M)ZQT), have their shapes correlated to the shape of the rivet/screw (34)7(37). For a better riveting the boring Q£) in the cylinder (V) and the boring (zT) in the hub (41) should be conical in the terminal part (a′″) from over the rivet head.

The outer filling valves QV) have the same construction as the inner rebound filling valves (30) and the inner compression filling valves (32), the only difference being the fact that for the outer filling valves (31), the plate/plates either curved/cylindrical (33), (35) are placed on the inner cylindrical side (V″) of the lateral body (c′″) of the annular cover (43) whose annular tabs (d) coats one or several holes (jll) and are fixed and sealed on the outer side of the inner cylinder Q). The inner sides of the lateral body (c′″) and of the annular tabs (d′″) form a toroidal enclosure (e′″) together with the outer surface (g′″) of the inner cylinder Q). In the lateral body (c′″) of the annular cover (43), to the arm ends (m), (n″) of the curved/cylindrical plate (33), (35) there are holes or slots (f″) to allow the liquid passing from the reservoir chamber (d) in the toroidal enclosure (e′″). The fixing of the curved/cylindrical plates Qy)ZQS) is done through the rivet/screw (34), (37) whose body passes through a boring Qi′″) provided in the lateral body (c′″) of the annular cover (43) and the boring (VΣ) provided in the plate (33), (35). The filling of the inner cylinder Q) with liquid from the reservoir chamber (d) is done through the holes (fΣ), in the toroidal enclosure (e′″) and from there through the hole/slot (ill) in the inner cylinder (Y), due to the force exercised by the liquid when the under pressure appears in the inner cylinder (Y), which is transmitted through the holes Q″) in the toroidal enclosure (e′″) determining the deformation of the lamella arms faa″), fa″) to the inside and thus opening the hole (f″) of the outer filling valve (31).

For improving the sealing of the filling valves, the whole area around the valves can be locally coated with a tin layer (44) or another soft material, so that after a short running in, the seal should be perfect.

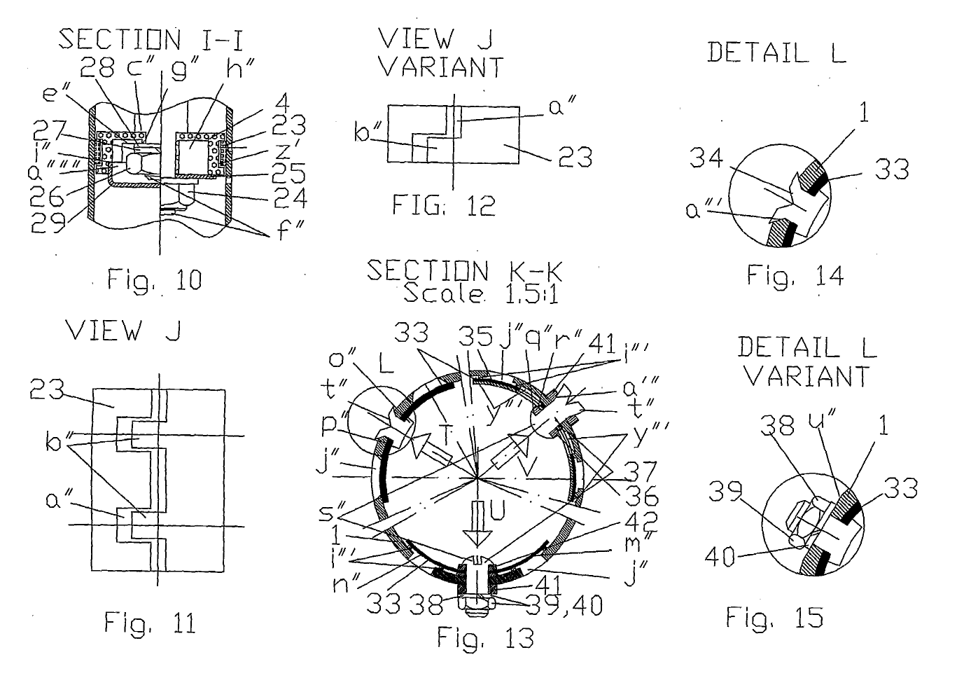

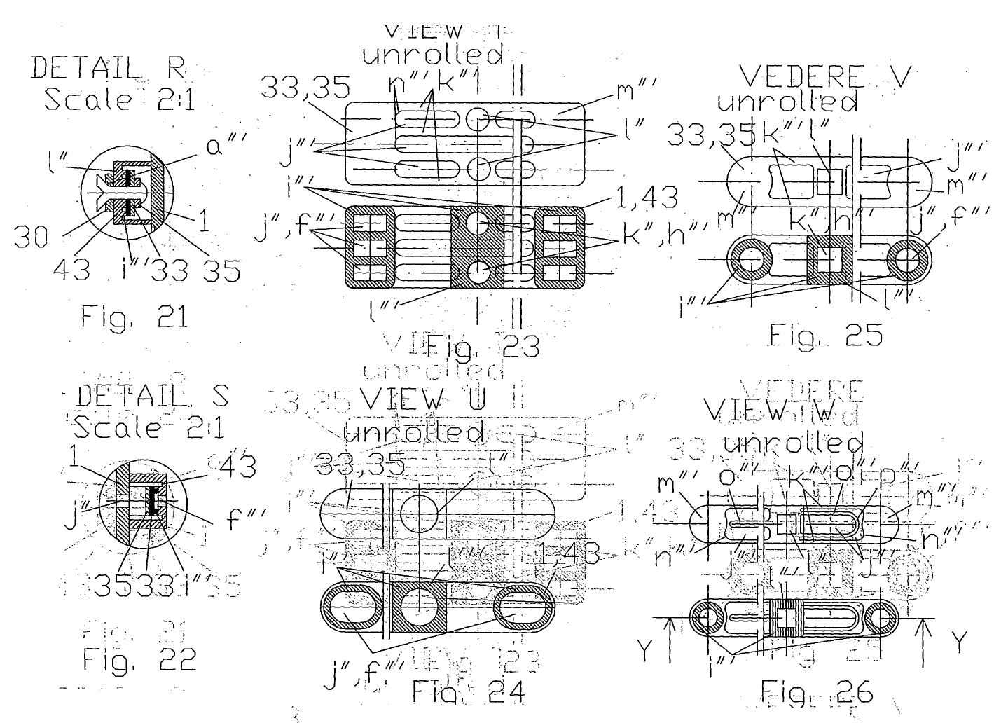

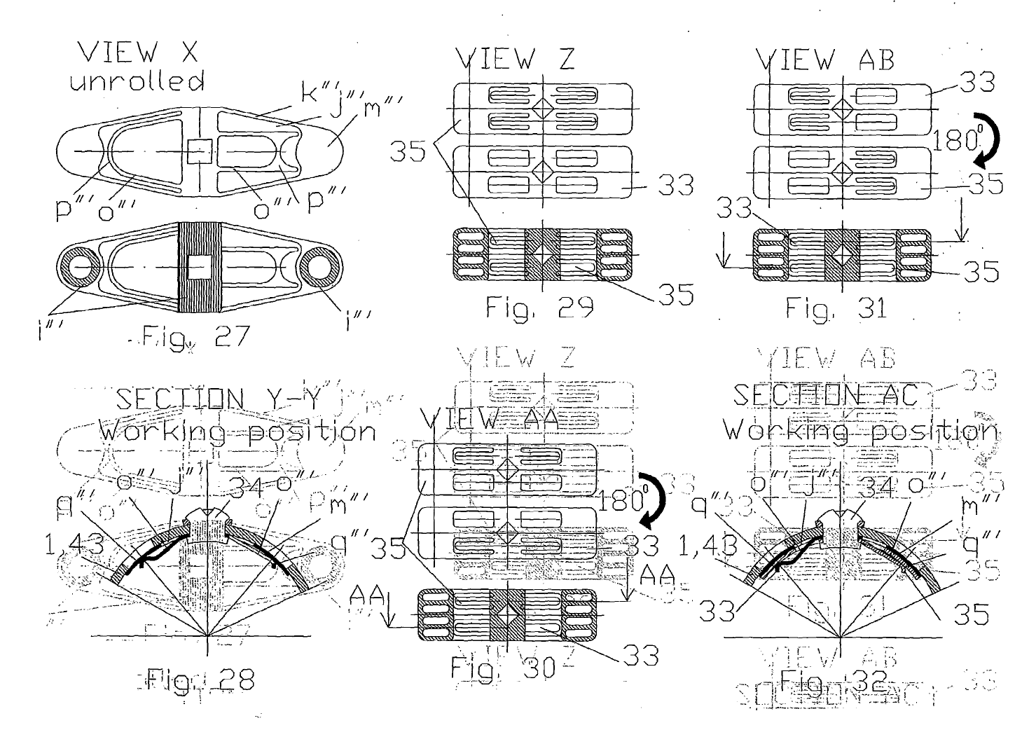

At the inner filling valves (30), (32) the plates (33), (35) can be placed directly on the cylindrical inner surface (v″) of the inner cylinder (I)—FIG. 13—Area T5 and for the outer filling valves (31) the plates (33), (35) can be placed directly on the inner cylindrical surface (b′″) of the annular cover (43)—FIG. 18—Area T, but in both cases, one should carry out the placement on some prominences (i′″) which result from adding or cutting (y′″) of material on/from the locating surfaces (V″), (b′″) respectively. In this way the contact pressure of the plates on the locating sides increases, improving the seal and the contact area of the plates with the liquid can be increased, over the one of the access holes, favoring the opening and a uniform flow. In the case of placing on prominences (T″), their profile is curved with the suitable shape or cylindrical. Obtaining the shapes (i′″) by adding material (electrolysis, plating, coating etc) is shown for the inner filling valves (30), (32), in FIG. 13—U view and for the outer filling valves in FIG. 18—U view. The shape achieving (i′″) for placing the rilling valves plates by cutting material (electrolysis, plating, coating) is shown for the inner filling valves (30), (32), in FIG. 13—V view, and for the outer filling valves in FIG. 18—V view. For the outer valve, the fixing of the plates in the case of shape (i′″), achieved by erosion is shown in detail R—FIG. 21, and the area of the liquid penetration in the version with a form achieved by adding material, in detail S—FIG. 22. The form of the plates curved/cylindrical (33), (35) is shown in detail together with the shape of the placing surfaces of the plates, which is shown with dashed line and hatch. For increasing the arms (m″), fa″) flexibility we provided channels (j′″) which can be symmetrical or asymmetrical and which form one or several arms (k′″) which connect the fixing area (Y″) to the sealing area of the plates (m″), fa″). The channels sides ( )′″) will be filleted fa″) in the joining area for eliminating the breaking prime. By a convenient profiling of the borings (f″) in the plates (33), (35) one or several tongues (o′″) are formed starting from under the profiled head (o″) of the rivet/screw (34) or from under the hub of the inner head (36). For tongues stiffening (oil!), these can be united at their top or to the inside trough a link element fa′″) of a convenient shape. It's advisable that the tongues should be bordered (q′″) to slide on the plate. The curvature of the curved/cylindrical plates (33), (35) when free is chosen so that when mounted to sit perfectly on the holes of the oil penetration (j″), (f″). The tongues (o′″) have a smaller curvature than that of the arms (k) so that, although being shorter they impress on the sealing area (mill), contributing to a better setting of the plates on holes and to achieving a more suitable elastic characteristic. In FIG. 27 there is a shape, which increases the radial flexibility, increasing the axial rigidity and thus improving the setting on the sealing area. When several plates (33), (35) one or both can have tongues (o′″) in which case the borings and tongues are correlated, the tongues of both plates impressing above the sealing area faa′″) of the plate (35). FIG. 29 shows two superimposed plates, the plate (33) not having tongues and the plate (35) has four tongues. To reduce the number of manufacturing devices one can use identical plates having two tongues (bill) placed on the same part of one of the symmetry axes. Then one of the two plates is used rotated so that the tongues (o′″) of the plate (33) go through the slots (jlH) of the plate (35).

FIG. 30, 31 show two ways of achieving some identical plates (33), (35) but used rotated and

FIG. 32 shows a section showing a valve achieved with the two identical plates in working position.

The pressure of opening the valves (30), (31), (32) is regulated by controlling the curvature of their arms fk′″), the thickness of each plate (33), (35), the number of plates, the outer and inner shape (the boring shape) and the sizes and shape of the tongues fo′″).

FIG. 48—left section shows a valve with elastic plates, open.

The metering holes (aQ, (V) can be achieved directly or gradually, or in steps, depending on the technology used.

If the size and/or the shape of the metering holes (al), (V) provided in the inner cylinder (V) can't be controlled, in the inner cylinder (1) there are functional holes (r′″). An annular body (45) placed on the inner cylinder (1) cover the functional holes (r′″). The annular body (45) is placed so that the metering hole (s′″) provided in it to center over the hole (r′″). The same thing is done when the hole (t) provided in the inner cylinder (1) has been wrongly processed; over it there is an annular body (45) with the hole (s′″% suitably processed. The hub (45) can contain several holes differently processed and the optimum hole (s′″) should be applied over the hole (r′″)/(f″).

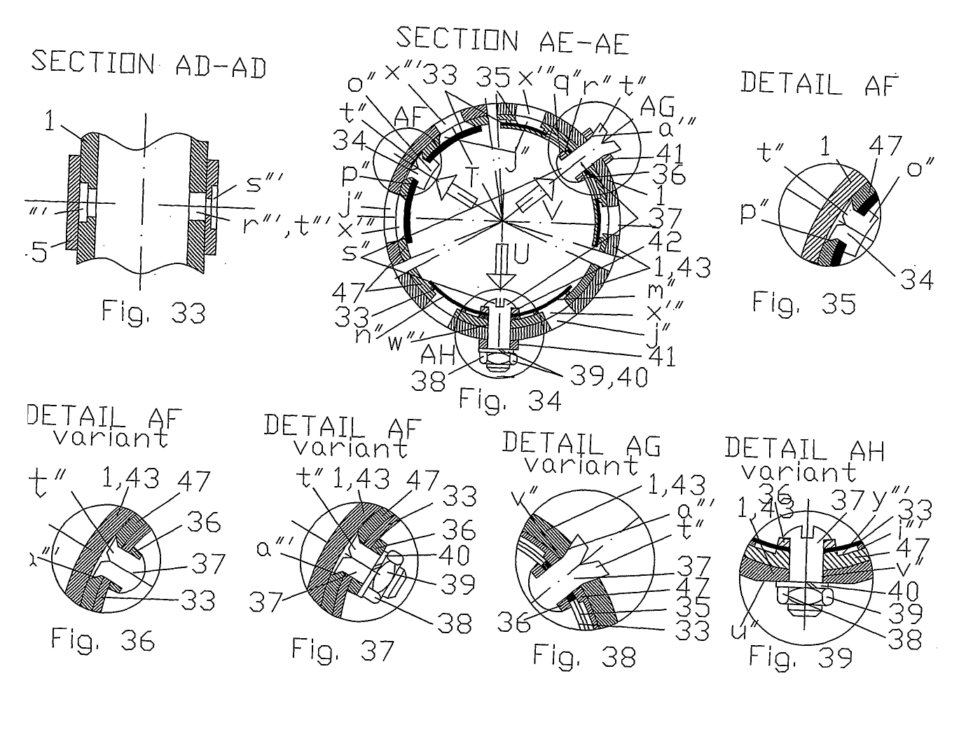

When the hole (t′″) has been positioned by mistake in that position, the annular body (45) does not have a hole or is fixed with the hole rotated as the wrong one—FIG. 33. The surfaces (b′″) of the annular cover (43) and the prominences (i′″) can have a curved/cylindrical/planar shape and the plates will have the surfaces correlated with these.

Automotive self-adjustable shock absorber with self-correcting damping characteristic, having curved, cylindrical and planar filling valves, according to the second accomplishing example—FIG. 34-39, uses for filling one or more rebound and/or compression filling valves (46) on the inner annular body, located on the inner annular body (47), formed from the symmetric or asymmetric plate (33) and eventually one or more additional symmetric or asymmetric plates (35), the plate (33) being placed on the inner face (u′″) on the inner annular body (47) rigidly and tightly placed inside the inner cylinder (V). For this purpose the inner annular body (47) has the outer face (v′″) processed in correlation with the inner face of the inner cylinder Q). The plates are fixed through the rivet/screw (34)7(37), passing through the boring (w′″), from the inner annular body (47). The rivet/screw (34)7(37), either has the heads (O5 GO, buried in the annular body (47), in order not to exceed the inside diameter of the inner cylinder Q), or it also passes through a boring Q?) carried out in the inner cylinder (T), they being fixed on its exterior through one of the previous procedures, used at the inner valves (30), (32) or at the outer filling valves (31).

There are some borings (x′″) for the penetration of the motive fluid in the inner annular body (47), under the arms (m̂), (EQ, of the plates (33). The borings (x′″) from the inner annular body (47) correspond to the borings (ĵ from the inner cylinder (V). FIG. 34 represents in the area T, the solution for the location of the plate (33) directly on the inner face (u′″) of the inner annular body (47), in the U area there is the solution for the location of the plate (33) on the prominences (i′″) applied on the inner face (u′″\ of the inner annular body (47), and in the V area there is the solution for the location of the plate (33) on the prominences (i′″), resulted from the cutting of some troughs (y′″) in the inner face (u′″), of the inner annular body (47). The solutions are similar to those from the inner valves (30), (32)—FIG. 13 and outer filling valves (31)—FIG. 18. FIGS. 34-39 show more achievement solutions, with the fastening of the rivet/screw (34)7(37), with the head (cT)/(s?), towards the interior of the inner annular body (47), or towards its exterior, of the inner cylinder (Y) respectively. When the location of the rivet/screw head (34)/(37), is done directly on the outer face (v′″), of the inner annular body (47), or outside the inner cylinder (Y), depending on the fastening element, at the end of the borings (w′″)/(k″), for the passing of the rivet/screw (34)7(37), a planished surface (t£), or a conical boring (a′″) are carried out. When the fastening is done through the rivet/screw head (34)7(37), passing through a boring QO, carried out in the inner cylinder (Y), the inner annular body (47), can be replaced by one or more arcs of annular body that contain fastening elements and valves.

Through the same procedures, the inner annular body (47), or arcs from it are applied inside the annular cover (43), of the outer filling valve (31).

The surfaces (b′″)/(u), of the annular cover (43)/of the inner annular body (″47) and the prominences (i′″) can have a curved/cylindrical/planar shape and the plates will have the surfaces correlated with these.

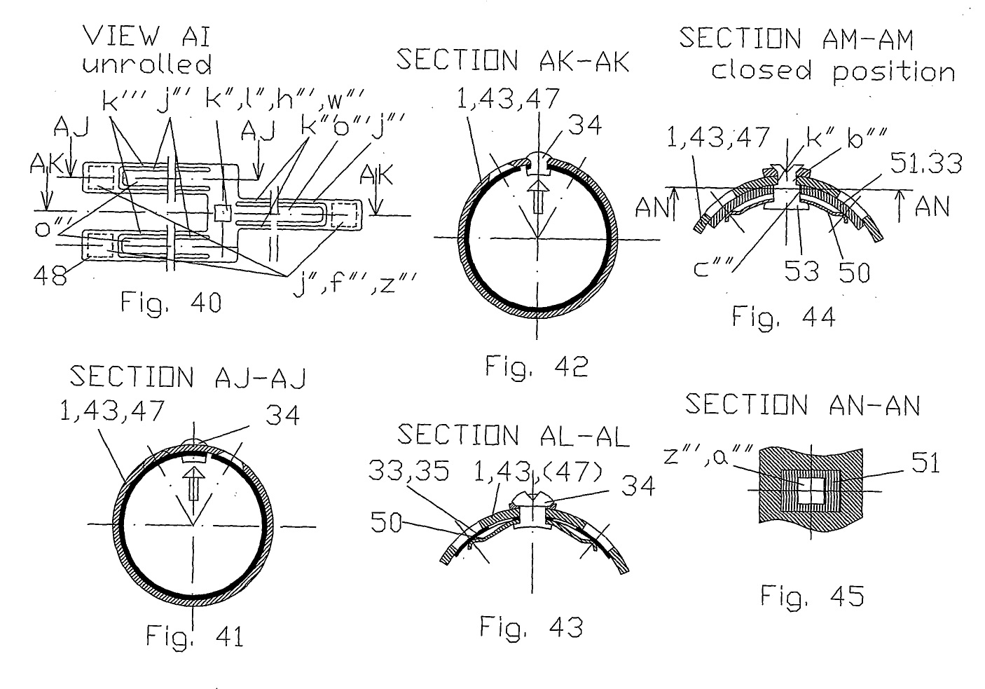

Automotive self-adjustable shock absorber with self-correcting damping characteristic, having curved, cylindrical and planar filling valves, according to the third accomplishing example—FIG. 40-42, uses for filling on rebound and/or compression one or more inner filling valves (30)7(32), located on the inner cylinder (Y) and/or one or more filling valves on the inner annular body (46), and/or one or more outer filling valves (31), formed by the three arm symmetric or asymmetric plate (48) and eventually one or more three arm additional symmetric or asymmetric plates (49). The plate (48) is located at the inner filling valves (30), (32) on the inner face (vfO of the inner cylinder (Y) at the outer filling valves (31) on the inner face (b′″) of the annular cover (43), at the valves on the inner annular body (46), on the inner face GO, of the inner annular body (47).

The additional plates (49), are located over the plates (48), all of them being fixed through the rivet/screw (34), (37), passing through the boring (T), from the plates (48), (49) and the borings (k″) from the inner cylinder (Y) at the inner valves (30), (32), through the boring (h″?), at the outer filling valves (31) and through the boring (w′″), (k̂ eventually, at the valves on the inner annular body (46).

The filling orifices (j£), from the inner cylinder (Y), at the inner filling valves (30), (32), the filling orifices (f″) from the annular cover (43) respectively, at the outer filling valves (31), the filling orifices (x), on the inner annular body (47) respectively, at the valves on the inner annular body (46), are located on one side and the other of the orifices (k″), for fastening of the plates (48)7(49), symmetrically or asymmetrically—FIG. 40-42. In order to increase the radial flexibility in the arms (m″), (rf!) of the plates (48), (49), there are some slots (?″\ that form the arms (k′″) and if it is necessary some tongues (o′″), that are provided with an inflection/rim (3̂) at the end.

The tongues (o′″) are profiled in such a way as to be located on the seal area (m′″), of the plate (48), for the one plate solution, and of the last plate (49), for the more plates solution, respectively. The location of the plate (48) can be done directly on the inner curved/cylindrical surface (v″)/(b′″)/(u′″), of the inner cylinder (1)/annular cover (43)/of the inner annular body (47), at the inner valves (30), (32)/the outer filling valves (31)/the valves on the inner annular body (46), or on the prominences (i′″) applied on the inner curved/cylindrical surface of the inner cylinder (1)/of the annular cover (43)/of the inner annular body (47), at the inner valves (30), (32)/outer filling valves (31)/the valves on the inner annular body (46), or on the prominences (P″) resulted from the cutting of the material (y′″), from the inner curved/cylindrical face (v″)/(b′″V (uw>). of the inner cylinder (1)/of the annular cover (43)/of the inner annular body (47), at the inner valves (30), (32)/outer filling valves (31)/the valves on the inner annular body (46).

The surfaces 03′″V(U′″), of the annular cover (43)/of the inner annular body (47) and the prominences (i′″) can have a curved/cylindrical/planar shape and the plates will have the surfaces correlated with these.

Automotive self-adjustable shock absorber with self-correcting damping characteristic, having curved, cylindrical and planar filling valves, according to the fourth accomplishing example—FIG. 43, uses, for filling on rebound and/or compression one or more inner filling valves (30)/(32) placed on the inner cylinder (Y) and/or one or more filling valves on the inner annular body (46) and/or one or more outer filling valves (31), made up of the symmetrical or asymmetrical plate, with two arms (33) and eventually one or more symmetrical or asymmetrical additional plates, with two arms (35), over which a spring plate (50) is placed, having one or two symmetrical or asymmetrical arms, which has a fastening area (Y″), continued with two tongues (o′″), finished with an inflexion/rim (q′″), that setting on the seal area (m′″), of the plates (33), in case of one-plate variant, respectively on the last plate (35), in case of more-plates variant. The rivet/screw (34)/(37), squeezes between the face (r£3, of the profiled head (c£) or the face (c£), of the inner head hub (36) and the inner face (yj3, of the inner cylinder (Y), for the inner valves (30), (32), respectively the face (b′″). of the annular cover (43) for the outer filling valves (31), respectively the face (u′″)/(v″) of the annular body (47)/of the inner cylinder (Y), for the valves on the inner hub (46). The valves operate by elasticity of the plates (33), (35), and of the tongues (o\ddot{υ}l), of the spring plate (50)—FIG. 43. The setting of the plate (33) can be made directly on the curved/cylindrical inner surface (v″)/(b′″)/(u′″), of the inner cylinder (1)/of the annular cover (43)/of the inner annular body (47), for the inner valves (30), (32)/outer filling valves (31)/the valves on the inner annular body (46), or on the protuberances (i′″) applied on the curved/cylindrical surface (y″)/(b′″)/(u′″) of the inner cylinder Q)/annular cover (43)/inner annular body (47), for the inner valves (30), (32)/outer filling valves (31)/the valves on the inner annular body (46), or on the protuberances (i′″) resulted by material cutting off (y′″), from the curved/cylindrical inner surface (v″)/(b′″)/(u′″), of the inner cylinder (1)/of the annular cover (43)/of the inner annular body (47), for the inner valves (30), (32)/the outer filling valves (31)/the valves on the inner annular body (46).

The surfaces (b′″)/(u′″), of the annular cover (43)/of the inner annular body (47) and the prominences (i′″) can have a curved/cylindrical/planar shape and the plates will have the surfaces correlated with these.

In the FIG. 48—right section, the open situation is presented.

Automotive self-adjustable shock absorber with self-correcting damping characteristic, having curved, cylindrical and planar filling valves, according to the fifth accomplishing example—FIG. 44-45, uses, for filling on rebound and/or compression one or more inner filling valves (30)/(32) placed on the inner cylinder (Y) and/or one or more filling valves on the inner annular body (46) and/or one or more outer filling valves (31), made up of the rigid or semi rigid/elastic plate (51)/(33), which is pushed over the holes of oil passing, by a spring plate (50). The plates (5Y)/(33), (50) have a guide area (T), continued with two arms (mO, (n£). In the center of the guide area (T) of the plates (51)/(33), one or more borings (z′″), respectively (a″″) in the plate (50), are machined, the ones by which the rivet/screw (53) with profiled head and body, passes. When a sole rivet/screw (53) is used, its body, in the guiding area (c″″), as well as the borings (z′″), (a″″), have a non-circular form (square, rectangular, oval, star-like), in order to prevent the gyration. When more rivets/screws (53) are used, the guide area (c″″), the borings (z′″), respectively (a″″), can be circular. The dimensions of the borings (z′″), (a″″), are such so that they ensure the sliding of the plates (51)/(33)/(50) on the guiding area (c″″), of the rivet/screw (53). In the end area the rivet/screw (53), has a collar (b′), with which it is fastened in the boring (̂), from the inner cylinder (V), at the inner valves (30), (32), respectively in the boring (h′″), from the annular cover (43), at the outer filling valves (31), respectively in the boring (w′″), from the inner annular body (47), at the valves (46) on the inner annular body. The guiding area (c″″), of the rivet/screw (53), is longer than the total value of the thickness of the plates (51)7(33), (50), so that the force of the liquid from the reservoir chamber (d), pressing over the plate (51), is transmitted to the arms of the spring plate (50), which, by elastic deformation allow the removing of the plate (51)/(33), of the inner side (VJ) of the inner cylinder (V), at the inner valves (30), (32), respectively of inner side (V″), of the annular cover (43), at the outer filling valves (31), respectively of inner side (u′″), of the inner annular body (47), at the valves on the inner annular body (46). The spring plate arms form (50), and the length of the guiding area (c″″), of the rivet/screw (53), are such so that the desired elasticity is reached. For the relief and when one desired the plate (51) to operate in an elastic manner, in the arms (m″), (n″), troughs of desired form are made. In FIG. (49), a valve with rigid plate (51), opened, is represented.

The fastening of the rivet/screw (53), outside, is made by riveting/nut, as for the previous solutions of inner valves (30), (32), outer filling valves (31), or on the inner annular body (46). The setting of the plate (51)/(33) can be made directly on the curved/cylindrical inner surface (v″)/(b′″)/(u′″), of the inner cylinder (1)/of the annular cover (43)/of the inner annular body (47), at the inner valves (30), (32)/outer filling valves (31)/valves on the inner annular body (46), or on the protuberances (i′″) applied on the curved/cylindrical inner surface (V″)/(D′″V(U′″), of the inner cylinder (1)/of the annular cover (43)/of the inner annular body (47), at the inner valves (30), (32)/outer filling valves (31 Waives on inner annular body (46), or on the protuberances (f″) resulted by material cutting off (V″), from the curve/cylindrical surface (V9Wb′″)/(u′″), of the inner cylinder (1)/of the annular cover (43)/of the inner annular body (47), at the inner valves (30), (32)/outer filling valves (31 Waives on the inner annular body (46).

The surfaces (b′″)/(u′″), of the annular cover (43)/of the inner annular body (47) and the prominences (i′″) can have a curved/cylindrical/planar shape and the plates will have the surfaces correlated with these.

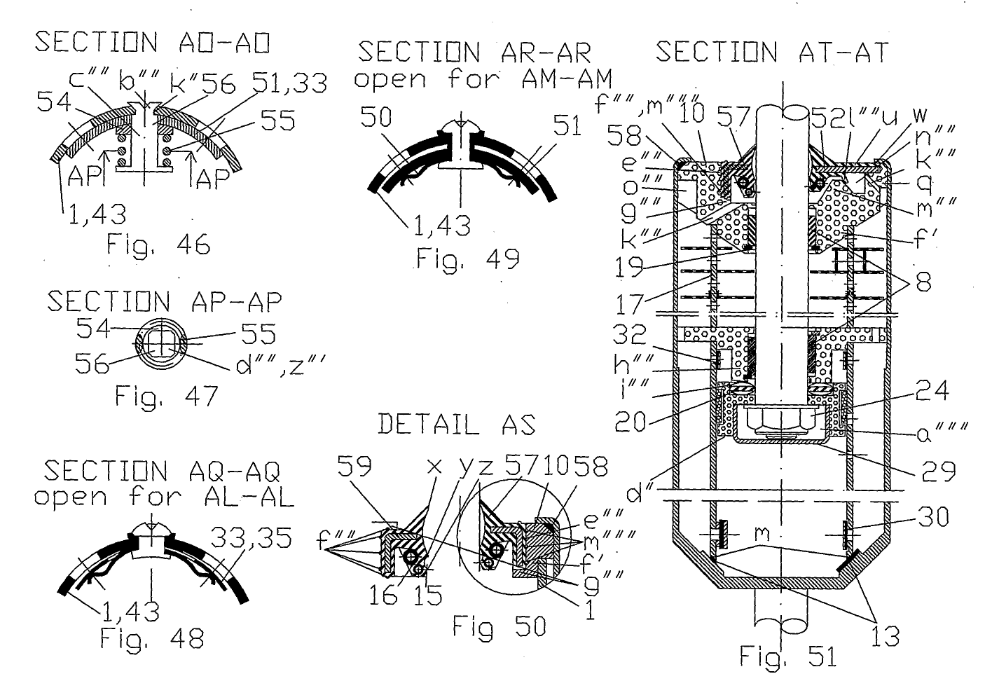

Automotive self-adjustable shock absorber with self-correcting damping characteristic, having curved, cylindrical and planar filling valves, according to the sixth accomplishing example—FIG. 46-47, uses, for filling on rebound and/or compression one or more inner filling valves (30)/(32) placed on the inner cylinder (V) and/or one or more filling valves on the inner annular body (46) and/or one or more outer filling valves (31), made up of the rigid/semi rigid/elastic plate (51)/(33), which is pressed over the oil holes, by a press beam (54), operated by a cylindrical spring (55), which leans against the profiled head (<£), of the rivet/screw (56). The press beam (54) is provided with one or more borings (d″″), in the central area, for sliding in the area (c″″). of the rivet/screw (56). The plate (51)/(33) has a guide area (F), continued with two arms (m̂, (n\ddot{υ}). In the center of the guiding area (F) of the plate (51)/(33), one or more borings (ẑ) are made, by which the rivet/screw (56), having profiled head and body, passes. When a sole rivet/screw (56) is used, to prevent rotation, its body, in the guide area, (c″″), and the borings (z′″), (d″″), preferable to have a non-circular form (square, rectangular, oval, star-like. When more rivets/screws (56) are used, the guide area (c″″), the borings (z′″), respectively (d″″), can be annular. The numbers of the spiral springs (55), and the length of the guiding area (c″″), are correlated with the number of the rivets/screws (56) and the desired elastic characteristic. The dimensions of the borings (z′″), (d″″), are such so that they assure the gliding of the plate (51)7(33) and of the press beams (54) on the guiding area (c″″), of the rivet/screw (56). Li the end area, the rivet/screw (56), has a collar (b″″), with which it is fastened in the boring (k*), from the inner cylinder (1), at the inner valves (30), (32), respectively in the boring (h″;), from the annular cover (43), at the outer filling valves (31), respectively in the boring (w′″), from the inner annular body (47), at the valves on the inner annular body (46). The guiding area (c′″), of the rivet/screw (56), is longer than the total value of the thickness of the plate (51)/(33), of the press beam (54) and of the spring coils (55), so that the force with which the liquid in the reservoir chamber (d), is pressing over the plate (51)7(33), is transmitted by the press beam (54) of the spring (55), which, by elastic deformation allows the removing of the plate (51)7(33), of the inner side (V̂) of the inner cylinder Q), at the inner valves (30), (32), respectively of inner side (b′″\ of the annular cover (43), at the outer filling valves (31), respectively of the inner side (u′″), of the inner annular body (47), at the valves on the inner annular body (46). The fastening of the rivet/screw (56), outside, is made by riveting/nut, as for the previous inner valves solutions (30), (32), outer filling valves (31), or on the inner annular body valves (46). The press beam (54) may be absent, in which situation we recommend modeled according to the spring (55), setting area on the plate (51)7(33). For relief and when the plate (51) needs operating in an elastic manner, in the arms (m″), (r£), channels of desired form are made. The location of the plate (51)7(33) can be made directly on the curved/cylindrical inner surface (v″)/(b′″)/(u′″), of the inner cylinder (X)IoS. the annular cover (43)/of the inner annular body (47), at the inner valves (30), (32)/the outer valves (3 l)/the valves on the inner annular body (46), or on the protuberances (i′″) applied on the curved/cylindrical inner surfaces (v″)/(b″″)/(u′″), of the inner cylinder (Y)I of the annular cover (43)/of the inner annular body (47), at the inner valves (30), (32)7 the outer valves (31)/the valves on the inner annular body (46), or on the protuberances (i′″) resulted by material cutting off (y′″), from the curved/cylindrical inner surface (v″)/(b)/(u′″), of the inner cylinder (1)/of the annular cover (43)/of the inner annular body (47), at the inner filling valves (30), (32)/the outer filling valves (31)/the filling valves on the inner annular body (46). The surfaces (b)/(u′″), of the annular cover (43)/of the inner annular body (47) and the prominences (V″) can have a curved/cylindrical/planar shape and the plates will have the surfaces correlated with these.

Automotive self-adjustable shock absorber with self-correcting damping characteristic, having curved, cylindrical and planar filling valves, according to the seventh accomplishing example—FIG. 50, 1, 3, has a sliding seal of the piston rod (5), made with a seal member (57), fastened in an aperture (e″″), of the outer upper lead (10). The seal of the outer upper lead (10), is made against the outer cylinder (6), by a gasket ring (58), of O type, introduced in an annular dell (t), made in the outer upper lid (10) and compressed by a closing rim (s), of the outer cylinder (6). The opening (j) of the seal member (57) is provided with lips (x), (y), (z) which separate two chambers (k″″″). (I″″″). Behind the lower chamber (!″″″) there is a circular trough (V) where a ring spring (15) is inserted to increase the lips (y), (z) tightening power. The lower lip (z) gauging is made through a dull edge (cP). A second trough (V) where a second ring spring (16) is inserted is provided for high pressures sealing. The trough (V) or the troughs (V), (V) position and the spring (15), respectively (15), (16) is done function of the version so that, one can obtain the desired tension distribution on the seal lips. The specific elements are shown in FIG. 3. The gasket (57) resistance is ensured by the inner reinforcement (59). In order to seal improving, some annular protuberances (f″) with appropriate section are provided on the side and on the front surfaces. The aperture (e″″) may be applied for the upper or the lower side of the outer upper lid QO), so that the collar (g″″) of axial limitation of the joint (57) can be placed upper or lower—FIG. 50. For a better fastening/sealing, the aperture (e″″) has some annular troughs (m″″″) in which the protuberances (f″″) are fastened/sealed.

Automotive self-adjustable shock absorber with self-correcting damping characteristic, having curved, cylindrical and planar filling valves, according to the eighths accomplishing example—FIG. 51, 6, 2, has the lower area (w′) of the upper inner cylinder head (T), continued with a circular extension (h″″) with a smaller diameter than that of the inner cylinder (1), in order to ensure a protected area for the inner compression filling valves (32). In order to reduce the length of the bumper, on the upper face (x̂) of the piston (4) a circular recess (i″″\ is carried out, where the rebound stopper bumper (20) enters totally or partially. The diameter of the recess (i″″) is bigger than that of the extension (h″″), in order to make possible the compression of the rebound stopper bumper (20).

In this way, the displacement during the rebound is controlled by the limitation of the deformation of the stopper bumper (20), through the limitation of the volume of the enclosure defined by the extension (h″″), and the recess (i″″). For the reduction of the overall dimensions, at the bottom of the piston (4), there is a recess fa″″″), where the self-locking collared nut (24) is buried.

In order to avoid the building up of the gas pocket, a mould lid (29), is pressed in the recess (a″″″), preferably up to the bottom of the recess, so that not to move at high pressures. The lower face (f′″″) of the lid (29) shall be under the level of the inner face (cT) of the piston (4). The shock absorber is provided with filling valves applied directly on the inner cylinder (Y), one or more compression inner filling valves (32), located at the top of the inner cylinder (Y), protected by the circular extension (h″″) and by one or more rebound inner filling valves (30), located at the bottom of the inner cylinder (Y).

In order to improve the guiding and taking over the side forces, the central area of the outer upper lid (10) is provided with a circular opening (e) slide adjusted with the rod (5), or an aperture (ρ_3, where an additional guide (8), slide adjusted with the rod (5) is introduced, the guiding being limited axially by a tab (g£) and eventually by the safety ring (19), fixed in a trough (f). The outer upper Hd (10), at the top is provided with a central aperture fe″″), where a gasket (57), limited axially by the tab (g″″\ is introduced. For improving the seal, some circular prominences (f″) with convenient section are provided on the side face and on the front faces. For a better fastening/sealing the aperture (e″″) has some circular borings (m″″″) where the prominences (f″) are fixed/sealed.

The fastening of the outer upper lid (10) against the outer cylinder (6), is done radial through the tab (g), rigidly located on the processed area (p), of the outer cylinder (6), and axially through the edge (s), of the outer cylinder (6). The fastening of the outer upper lid (10) against the inner cylinder (Y) is done through the tab (f).

A gasket (58), located into the annular dull (\ddot{ι}) achieves the outer upper lid (10) sealing against the outer cylinder (6). An enclosure fa″″) collects the oil rabble out by the gasket that is sent back in the reservoir chamber (d), through a boring (k″″).

In order to eliminate the gasket (58)—FIG. 51 right, the central aperture (e″″) is increased and it receives a lid (52), with the slide gasket (11) of the rod and with an upper extension (u), of the gasket (11) up to the end of the lid (52). The extension (u) is provided with a circular prominence (W), which improves the seal through the deformation. The axial fastening is done through the closing rim (s), of the outer cylinder (6). The gasket (YY) has all the elements previously defined and in addition a annular tongue (!″″), that is supported on a prominence (m″″), of the outer upper lid (10), defining the enclosure (n″″), that communicates with the reservoir chamber (d), through the discharge boring (k″″), impeding the oil penetration from the reservoir chamber (d), into the enclosure (n″″), but making possible the discharge of the rabble out oil into the reservoir chamber (d).

For the weight saving and material economy, some millings (ó″″) are provided on the side face of the outer upper lid (10). The outer cylinder (6) is closed at the bottom by a bottom outer lid (12) that inside, at the bottom, has a prominence Qc), its face (V) being plane, conically or spherically processed for the location-alignment of the inner cylinder (Y), whose lower face (m) is processed in correlation with the face (Y) of the prominence (k).

For a better setting—sealing, it is useful to coat the lower face (m) of the inner cylinder (Y) and/or of the face (V) of the prominence (k), with an easily deformable material (13).

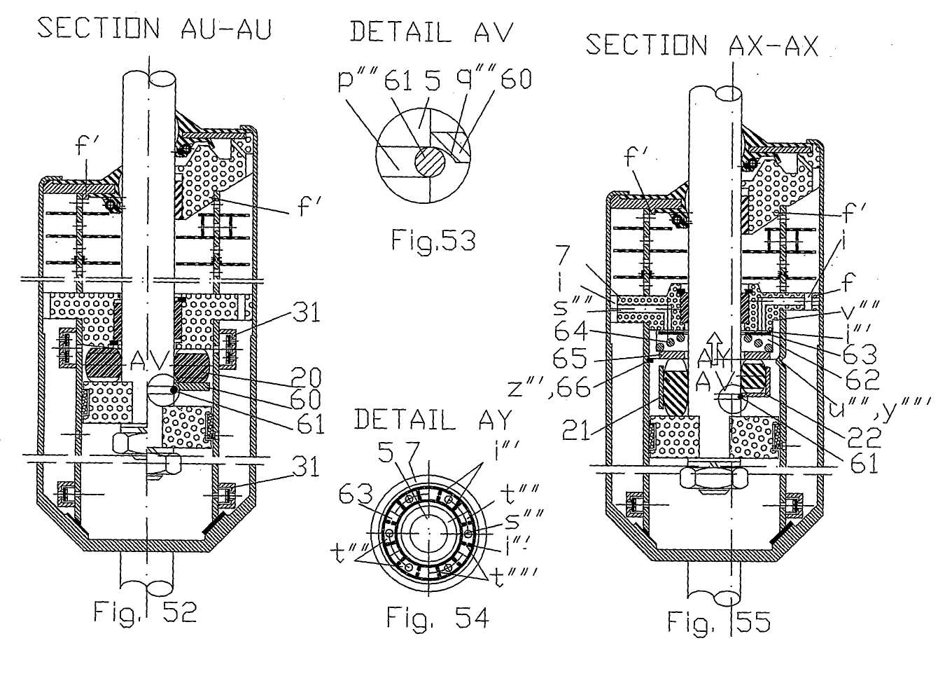

Automotive self-adjustable shock absorber with self-correcting damping characteristic, having curved, cylindrical and planar filling valves, according to the ninth accomplishing example—FIG. 52-53 is shown in the simple and double guiding version, simple, rebound stopper bumper (20), located on the piston (4), or on the annular hanger (60) and outer curved/cylindrical/filling valves (31), placed in the upper area of the inner cylinder (Y) for compression and at the bottom of the inner cylinder (Y) for rebound. The annular hanger (60), of the rebound stopper bumper (20), is fixed on the rod (5) through a securing ring (61), located in a trough (p″″) carried out in the piston rod (5). For this purpose, the hanger (60) has an annular recess (q″″) for the location of the securing ring (61).

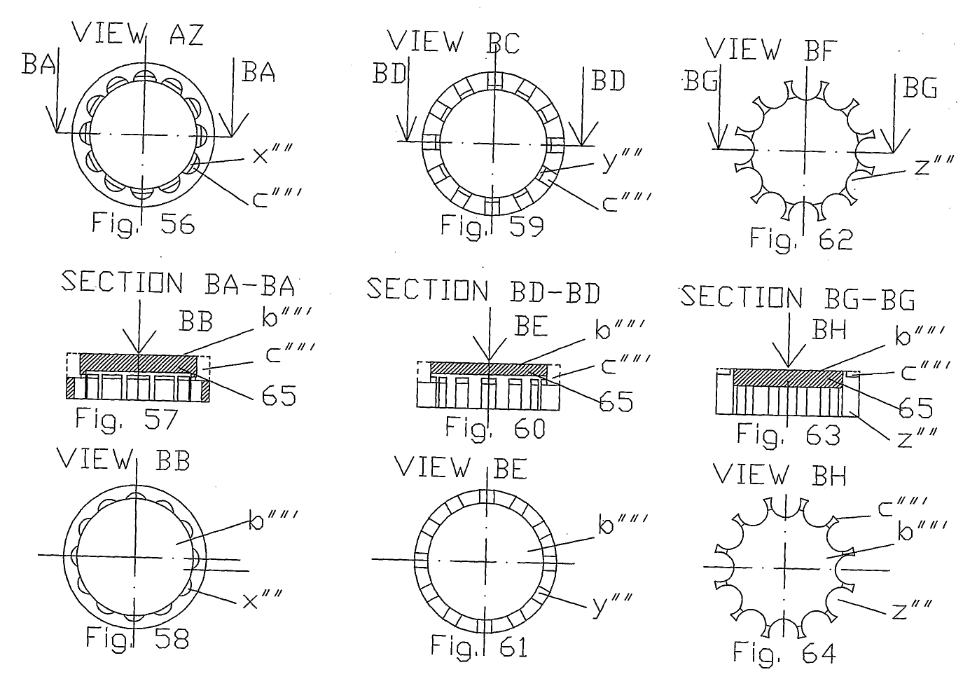

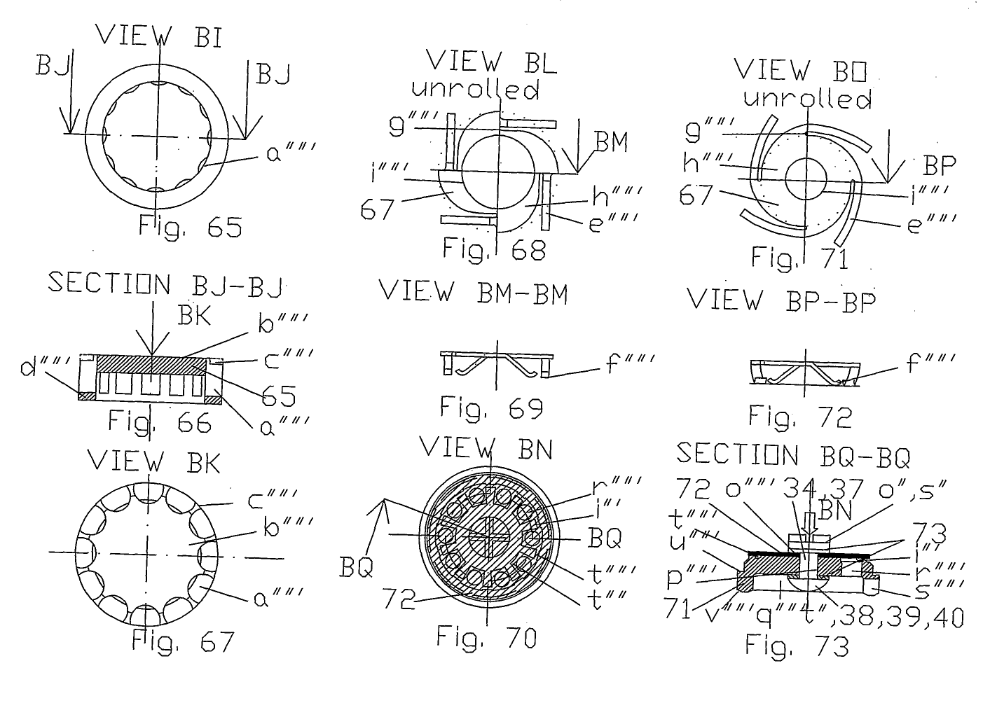

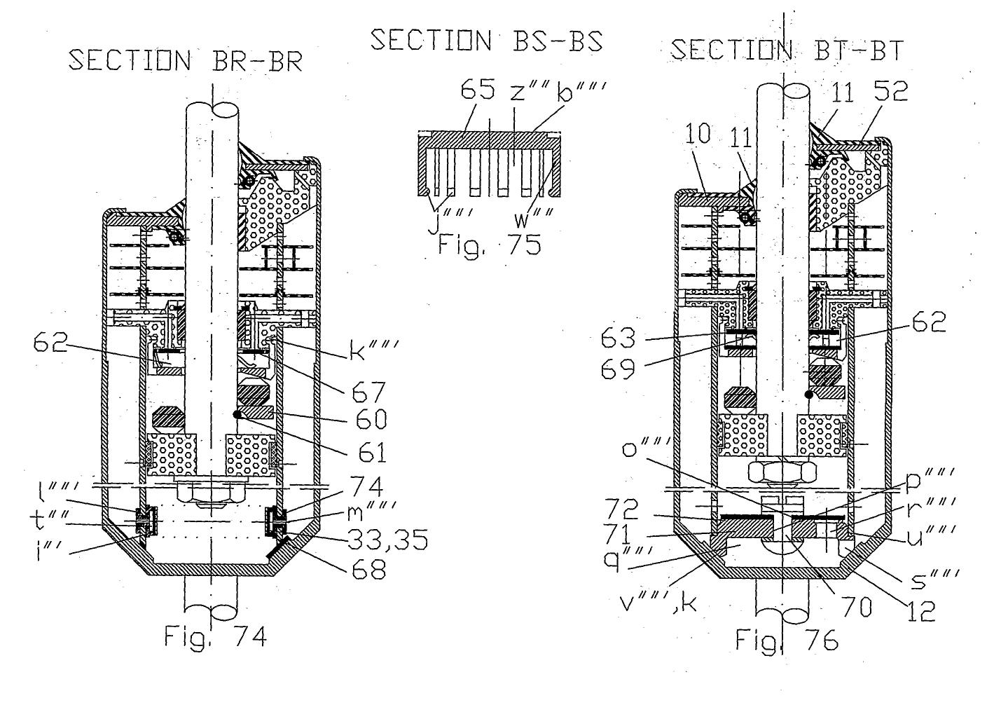

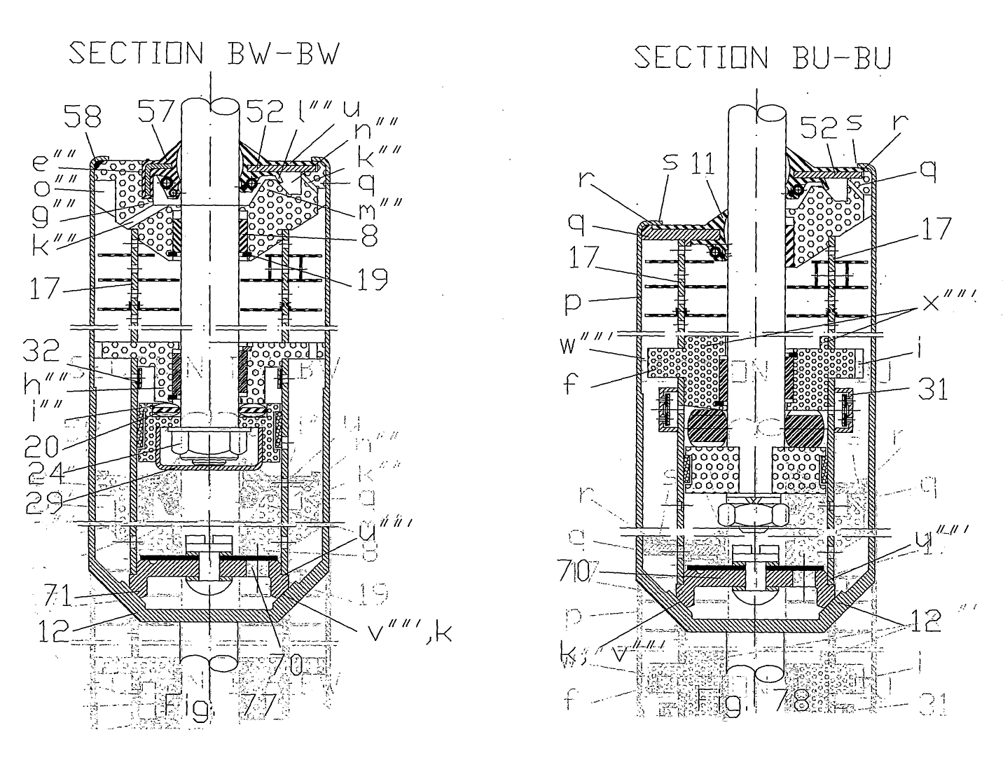

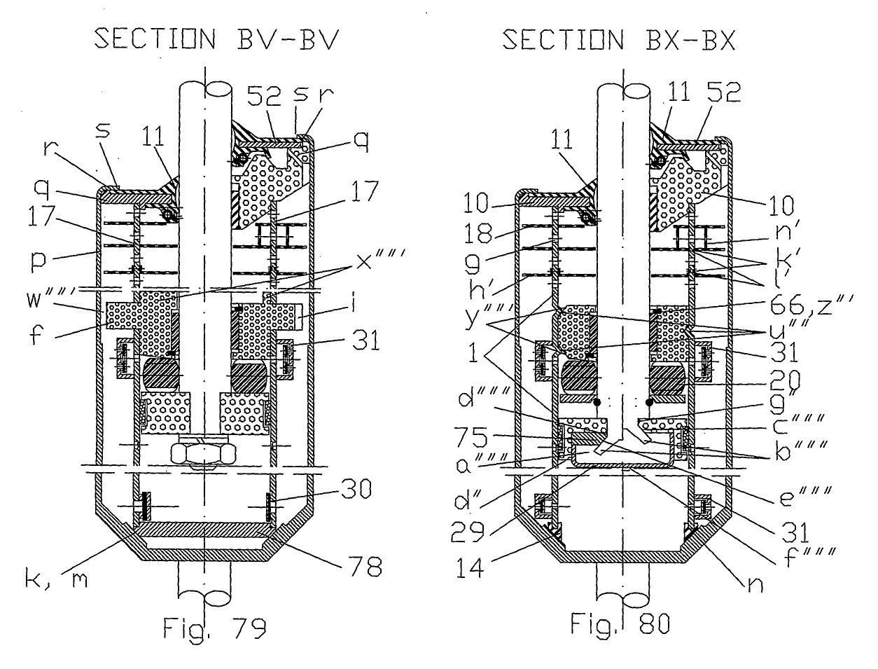

Automotive self-adjustable shock absorber with self-correcting damping characteristic, having curved, cylindrical and planar filling valves, according to the tenth accomplishing example—FIG. 54-67, 82 is shown in the simple and double guiding version, rebound stopper bumper (20), with tøtniting casing (21), setting on the piston (4), or on the cup hanger (22), fixed through the safety ring (61), the outer curved/cylindrical rebound filling valve (31), located at the bottom of the inner cylinder (Y) and the upper planar compression filling valve (62). The upper planar compression filling valve (62) is formed by a an annular plate (63), pressed on the lower face (w′), of the upper inner cylinder head (T), or on some prominences (f″), by a cylindrical or conical spiral spring (64), located on the inner face (r″″), of a cup (65), fixed between the upper inner cylinder head (T) and the inner cylinder (Y). The prominences (i), surrounding the supply borings (s″″), form one or more enclosures (t″″), connected to one or more circular troughs (t′″″), the size of the enclosures (t″″), being correlated with the strength of the plates.

On rebound, the annular plate (63) closes the borings (ŝ), or the enclosure/enclosures (t″″) formed by the prominences (i′″). The borings (s″″) communicate with the holes/millings (i) carried out in the collar (f) of the inner cylinder head (T). During the compression, the negative pressure under the annular plate (63) creates a force that deforms the spring (64), leading to opening of the upper planar valve (62), making possible the oil supply from the reservoir chamber (d).

The cup (65) is fixed on the inner cylinder (Y), either by pressing/binding, favored by some circular, fine mini-troughs (p″″″), in the inner cylinder head (T) and the cup (65)—FIG. 82, or by a continuous or discontinuous annular tab (u), carried out in the inner cylinder (Y), located on an annular dell/dull fy′″″) of the inner cylinder head (7), or by a securing ring (66), introduced into a trough (z′″″) from the inner cylinder Q).

For a good closing of the planar valve (62), it is recommendable that the cup (65) to be located on an annular tab fv″″) of the inner cylinder head (T), positioned above the lower face (wl) of the upper inner cylinder head (T). In order to ensure the oil transference from the cup (65) outwards in the skirt (w″″), there are some inner troughs fx″″) or perforated cuttings/slots (Y\ddot{υ}\ddot{υ}), or outer troughs fẑ), fa′″″).

If the shock absorber has no rebound stopper bumper (20) the cuttings can be applied on the whole length of the cup (65). When the rebound stopper bumper (20) is used, in order to avoid the obstructing of the cuttings by it and the deterioration of the stopper bumper caused by the edges, the cuttings (x″″), fv″″) shall be stopped under the face fb′″″) of the cup (65), and the cuttings (z″″) fa′″″), are made outside the cup (65).

A circular trough fc′″″), carried out in the face (b″), outwards, joins the borings fx″″), fy″″), fz″″), (a′″″). For the versions of cuttings fx″″), fy″″), that do not perforate the face fb′″″). the trough fc′″″) is compulsory.

At the version with the trough (a′″″) that are not applied on the whole length of the cup (65), the skirt (w″″) stays intact in area of location on the inner cylinder head (T), forming a continuous collar fd′″″) that setting improves.

Automotive self-adjustable shock absorber with self-correcting damping characteristic, having curved, cylindrical and planar filling valves, according to the eleventh accomplishing example—FIG. 71, 72, 74, 75, 87, is shown in the simple and double guiding version, rebound stopper bumper on the piston or on an annular hanger (60), fixed on the piston rod (I).

The upper planar valve (62) uses a spring plate (67), with the elastic legs fe′), right or curved, bent against the plane of the plate, the elasticity of the legs few′″″), ensuring the running of the valves (62).

At the lower end, the legs few′″″) have an inflexion/rim (P′″), in order to slip on the inner face of the cup (65). A fillet (g) ensures the elimination of the concentrators in the fastening area of the legs on the disc fh′″″) of the plate (67). An aperture (i′″″), in the disc fh′″″), ensures the passing of the rod (5). The cup of the valve (65) has the skirt fw″″), provided at the bottom with prominences (\ j′″″), that ensures the fastening into a trough fk′″″), carried out in the inner cylinder head (7).

The filling on rebound is achieved through a valve on the cast annular body (68), composed of curved/cylindrical/planar/plates (33), (35) setting directly on the curved/cylindrical/planar/inner surfaces of the cast annular body (74), or on the curved/cylindrical/planar prominences fi′″) from the inner surfaces of the cast annular body (74), made from easily fusible material or injected from resistant plastic material, inside the inner cylinder (V), or inside the annular cover (43). The cast annular body (74), contains the filling borings fm″″), the borings fw′″), for the passing of the rivet/screw (34)/(37), for the valves fastening and outer prominences (P″″), for sealing/fastening. The prominences fi′″) form the enclosures ft″″).

The plates (33), (35), are fastened through the previous procedures, shown at the valves on the inner annular body (46), or at the outer filling valves (31). The annular body (74) can be continuous or divided into arcs containing the seal and fastening areas, in this situation the fastening being ensured through the outer prominences fl′″″), extended from inside the inner cylinder (1)/annular body (47), through the increased filling orifices fjl!)/(f!).

Automotive self-adjustable shock absorber with self-correcting damping characteristic, having curved, cylindrical and planar filling valves according to the twelfth accomplishing example—FIG. 68, 69, 70, 73, 75, 76 are presented in the simple and double guiding version, rebound stopper bumper on piston or on annular hanger (60), fastened on the piston rod (1). The filling on compression is made by the upper planar valve (62), which uses an annular plate (63), and a disk spring (67) with legs (&′″″) upward (69). The legs (e′″″), press by elasticity over the plate (63), ensuring the operation of the valve (62). At the lower end the legs (e′″″), have an inflection/rim (f′″″). to glide on the interior side of the plate (63). A fillet (g\ddot{υ}\ddot{υ}) ensures the elimination of the concentrators in the area where the legs are connected to the disk (h′″″) of the plate (67). A central aperture (TlLO ensures the piston rod (5) passing. For higher pressures the plate (67) has the legs downward its disk overleaping on the plate (63). The filling on rebound is ensured by a lower planar filling valve (7Q)5 made up of the valve body (71), on whose upper planar side (n′″″), or on some protuberances (i5″) the elastic plate (72) is put, fastened on the valve body (71), through a rivet screw (34)7(37) which goes though the canal Co′″″) from the plate (72) and through the canal CP′″″) from the valve body (71). Between the head (s″) of the rivet/screw with planar head (37) and the plate (63) and the lower side of the valve body (71) and the lower head (O of the rivet Q4)/QT)/mxt (38)/(39) a planar washer (73) is placed. In the lower area, the valve body (71) has an opening (q), which is connected to the compressing compartment (c) through some borings (r′″″) and with the reservoir chamber (d) through some borings/millings (s′″″), made in the lower part of the valve body (71).

The protuberances (i′″) which surround the borings (r′″″), make up one or more enclosures ft″″), connected to one or more circular troughs ft′″″), the size of the enclosures ft″″) being correlated with the plates resistance.

The fastening of the valve body (71) is made towards the inner cylinder (V) through a collar Cu′″″) and towards the protuberance ffc) from the bottom outer Kd (12), by an area fv′″″) with me form correlated with (k).

Automotive self-adjustable shock absorber with self-correcting damping characteristic, having curved, cylindrical and planar filling valves according to the thirteenth accomplishing example—FIG. 77 is shown in the variant with double guide, gliding sealing towards the piston rod (V), with the removable member seal (57) and towards the outer cylinder (6), through the gasket ring O (58), or with outer upper Hd (10), containing gliding sealing members of the piston rod and seal towards the outer cylinder (6), rebound stopper bumper in the piston, filling on compression through the inner curved/cylindrical valve (32), placed on the upper side of the inner cylinder (V), protected by the lower extension fh″″) of the inner cylinder head (T) and the planar rebound filling valve (70) placed on the lower side of the inner cylinder (V).

Automotive self-adjustable shock absorber with self-correcting damping characteristic, having curved, cylindrical and planar filling valves according to the fourteenth accomplishing example—FIG. 78 is shown in the variant with simple and double guiding version, rebound stopper bumper (20) on the piston (4), filling on compression with outer curved/cylindrical filling valves (31) placed on the upper side of the inner cylinder (I), filling on rebound through the planar filling valve (70), placed on the lower side of the inner cylinder (V). The upper inner cylinder head (T) has a collar (f) with the diameter smaller than the inner diameter of the outer cylinder (6), so that those two parts, respectively the inner cylinder head (T) and the outer cylinder (6) are not in contact in the collar (f) area, where an annular enclosure fw′″″) separates them, the collar (f) having only the purpose of attenuating the liquid movement in the reservoir chamber (d). A full or annular collar fx′″″) on the upper side of the inner cylinder head (T) ensures the alignment of the cylinder (17) towards the upper inner cylinder head (T). Thus the assembly made up of the outer upper lid (10), the cylinder (17) of the balance chamber, the upper inner cylinder head (T), the inner cylinder (V), the valve body (71) are aligned/fastened towards the lower outer cylinder (6), lower through the surface (v′″″) from the valve body (71), put on the collar (k) from the outer cylinder (6) and upper by the collar (g), and the face (r), of the outer upper lid (10), set on the face (p), respectively on the closing rim (s), of the outer cylinder (6). Thus are ensured a perfect alignment of the elements: piston (4), inner cylinder (V), guide (8) in the upper inner cylinder head (T), additional guide (8), in the outer upper lid (10), removable seal member (57), respectively the gasket (11) applied on the outer lid (52).

Automotive self-adjustable shock absorber with self-correcting damping characteristic, having curved, cylindrical and planar filling valves according to the fifteenth accomplishing example—FIG. 19, is shown in the simple and double-guide version, rebound stopper bumper (20), on the piston (4), filling on compression with the outer curved/cylindrical valve (31), placed on the upper side of the inner cylinder Q), filling on rebound with the inner curved/cylindrical valve (30), placed on the lower side of the inner cylinder (V). The upper inner cylinder head (T), has the collar (T), with a diameter smaller than the inner diameter of the machined area (p) of the outer cylinder (6), so that the two parts, respectively the inner cylinder head (T) and the outer cylinder (6), are not in contact, in the collar φ area, where an annular enclosure (w′″″) separates them, the collar φ having only the purpose of attenuating the liquid movement in the reservoir chamber (d). A full or annular collar (x′″″) on the upper side of the upper inner cylinder head (7) ensures the alignment of the cylinder (17) to the upper inner cylinder head (T).

On the lower side the inner cylinder (V), is closed with the lower inner cylinder head (78) towards which is aligned by the collar (u′″″). The lower inner cylinder head (78) set against and is aligned with the surface (v′″″), on the inner collar (k), of the bottom outer lid (12), of the outer cylinder (6).

Thus the assembly made up of the outer upper lid (10), the cylinder (17) of the balance chamber, the upper inner cylinder head (T), the inner cylinder (V), the lower inner cylinder head (78), are aligned/fastened to the outer inner cylinder (6), lower through the surface (v′″″), from the lower inner cylinder head (78), placed on the collar (k) from the outer cylinder (6) and upper through the collar (q), and the face (r), of the outer upper Hd (10), placed on the face (p), respectively the closing rim (s), of the outer cylinder (6). Thus is ensured a perfect alignment of the elements: piston (4), inner cylinder (I)5 guide (8) in the upper inner cylinder head (T), additional guide (8), in the outer upper lid (10), seal member (11), in the outer lids (10) or (52).

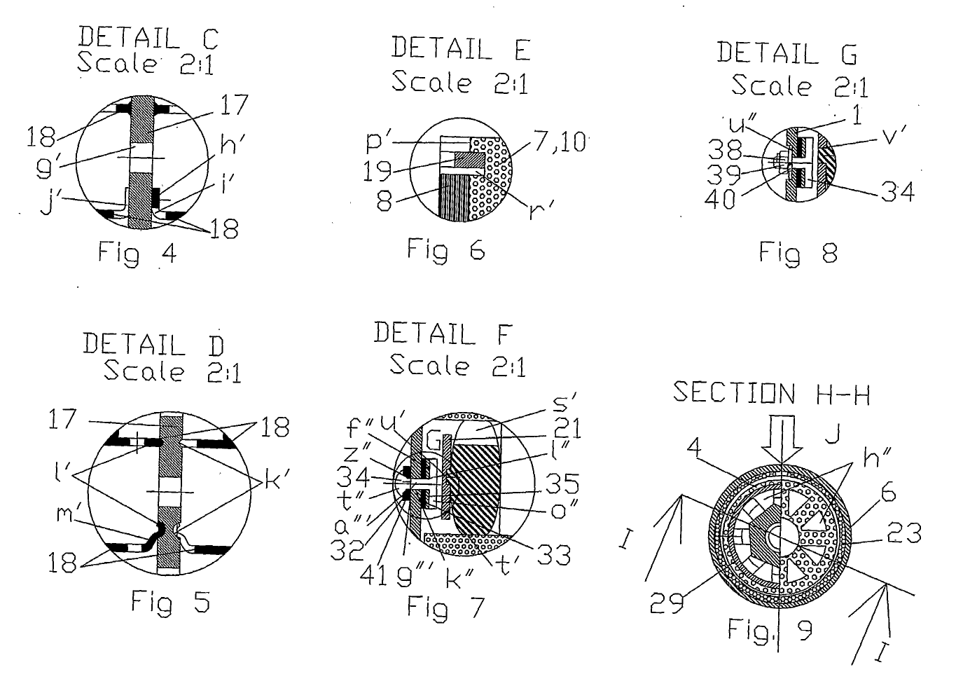

Automotive self-adjustable shock absorber with self-correcting damping characteristic, having curved, cylindrical and planar filling valves according to the sixteenth accomplishing example—FIG. 80, FIG. 4, FIG. 5, FIG. 82, FIG. 83, is shown in the simple and double-guide variant, rebound stopper bumper (20) on the annular hanger (60), filling on compression through the curved/cylindrical outer filling valves (31), placed on the upper side of the inner cylinder (V), filling on rebound through the curved/cylindrical outer filling valves (31), placed on the lower side of the inner cylinder (V).

The inner cylinder (V), is extended on the upper side at the level of the outer upper lid (10), fastening/aligning itself on its collar (F), taking over even the cylinder (17) function that of forming the balance chamber (h), and for this purpose it contains holes (g), for the liquid flow and also disks (18) provided with the holes (g!) of communication. The disks (18) are fastened outside and/or inside the inner cylinder (V), either in a rigid manner, by pressing or by soldering, or by form. A collar (b/) with some holes (\ddot{ι}), or channels/slots Ql), facilitates the cupping. At form fastening, on the inner cylinder Q), are provided some troughs or hollows (kθ, where the prominences (V) of the disks (18) are fastened. It is advisable that the protuberances (V) of the disks (18) are inclined in the pre-closing area (m′). For stiffening, in case of more disks (18), these can assembly two or more by connecting links (jg!) provided with holes (gl).

The upper inner cylinder head (T) has the diameter correlated with the inner diameter of the inner cylinder Q), in order to enter pressed in it. The fastening of the upper inner cylinder head (T) in the inner cylinder (1), is made by pressing/binding favored by some fine circular troughs (s″) in the inner cylinder head (J) and the inner cylinder Q), either by one or more annular cupping (u″″), continuous or discontinuous, in the inner cylinder Q), put on annular dell/dull (y′″″) of the inner cylinder head (T), either by safety rings (66), introduced in hollows (z′″″) from the inner cylinder Q).

The piston (4) has a cutting (a″″″) on the lower side, where there is the flanged head (b″″″), formed by flanging/molding (at cool) of the lower end of the piston rod (5). The head (b″″″), fastens the piston (4), on the piston rod (5), directly, when, in order to facilitate the flanging/molding the boring (g″) for piston rod passing (5), is conic in the lower area (c″″″), either indirectly, by means of a washer (75), which has in the boring (d″″″), for the piston rod passing, the lower part conic (e″″″) thus facilitating the flanging.

So that an elastic gas layer does not form, the cutting (a″″″), is closed with a lid (29), which leans directly on the bottom of the cutting (a″″″), respectively on the washer (75), thus the lower side (f*″″> of the lid (29), is under the lower side (cT), of the piston (4).

Automotive self-adjustable shock absorber with self-correcting damping characteristic, having curved, cylindrical and planar filling valves according to the seventeenth accomplishing example—FIG. 81, is shown in the single-guide variant, rebound stopper bumper (20), fastened on the piston rod Q), placed in the piston (4), the filling on compression with inner curved/cylindrical valve (32), placed on the upper side of the inner cylinder Q), filling on rebound with the planar rebound filling valve (70), placed on the lower side of the inner cylinder Q). in order to ensure a protected area for the inner valves (32), for filling on compression, the inner part (w′) of the inner cylinder head (T), is continued with a circular extension (Sh″″) having a diameter smaller than that of the inner cylinder Q).

The inner cylinder Q), is extended on the upper side at the level of the outer upper lid (10), fastening/centering itself on its collar (T), taking over also the cylinder (17) function of forming the balance chamber (h), and for this purpose, it contains slots (g[), for the liquid passing and also some disks (18) provided with holes (g) for communication. The disks (18) are fastened outside and/or inside the inner cylinder Q), either in a rigid manner, by pressing or by soldering, or by form. A collar (V) with some holes (T), or channels/slots Ql), facilitates the cupping. At form fastening, on the inner cylinder Q), are provided some troughs or hollows (Y), where the prominences (V) of the disks (18) are fastened. It is advisable that the protuberances (V) of the disks (18) are inclined in the pre-closing area (m/). For stiffening, in case of more disks (18), these can assembly two or more by connecting links (ti) provided with holes (oj).

The upper inner cylinder head (7) has the diameter correlated with the inner diameter of the inner cylinder Q), in order to enter pressed in it. The fastening of the upper inner cylinder head (7) in the inner cylinder Q), is made by pressing/binding allowed by some fine circular troughs (s″″) in the inner cylinder head (T) and the inner cylinder (1), either by one or more annular cupping (“u″”), continuous or discontinuous, in the inner cylinder (Y), put on annular dell/dull (y′″″) of the inner cylinder head (T), either by safety rings (66), introduced in hollows (z′″″> from the inner cylinder (Y).

In order to reduce the shock absorber length, on the upper surface (xl) of the piston (4) an annular cupping (i″″) is made, and the rebound stopper bumper (20) enters totally or partially in this cutting. The diameter of the cupping (T̂) is bigger that that of the extension (h″″), in order to allow the compression of the rebound stopper bumper (20). Thus, the rebound movement is checked by the bumper (20) deformation limited by the volume enclosure defined by the extension (h″″) and the cupping (i″″).

The piston (4), has, on the lower side, a cutting (a″″″), for the material economy, closed with a lid (76) on the lower side, a lid which is provided, on the upper side, with an annular collar (g″), assuring the radial alignment against to the cutting (a″″″) and the axial fastening/setting on the lower surface (cT), of the piston (4). The lid (76) is provided with a central aperture (h″″″), by which the piston rod (5) passes being aligned in a radial manner. The head (b″″″), formed by heat flanging of the lower end of the piston rod (5) fastens with the collar (ĉ) of the piston rod (5) the assembly piston (4), the lid (76). In order to facilitate the flanging of the head fb″″″), the boring (h″″″), is conic on the lower side (i″″″). We recommend the indentations Q″″″), from the flanged head are horizontal or inclined so that the vapor lock does not appear, for this purpose their level being under the level of the lower surface (d̂), of the piston (4).

Automotive self-adjustable shock absorber with self-correcting damping characteristic, having curved, cylindrical and planar filling valves according to the eighteenth accomplishing example—FIG. 82, 83 is shown in the double guide variant, sealing with removable gasket (57), or with seal member (11) applied on the Hd (52), rebound stopper bumper (20), with limiting casing QY), on the piston (4), or stopper bumper (20), in the cup hanger (22), fastened on the piston rod (Y), by a safety ring (61), filling on compression with the inner curved/cylindrical valve (32), placed on the upper side of the inner cylinder (Y), filling on rebound with the inner curved/cylindrical valve (30), placed on the lower side of the inner cylinder (Y). The inner cylinder (Y), is extended on the upper side at the level of the outer upper lid (10), fastening/aligning itself on its collar (f), taking over also the cylinder (17) function of forming the balance chamber (K), purpose for which it contains holes (g!), for the liquid passing and also some disks (18) provided with holes (g) for communication. The disks (18) are fastened outside and/or inside the inner cylinder (Y), either rigidly by pressing or soldering, or by form. A collar (h/) with some holes (V), or channels/slots (V), facilitates the cupping. When form fastening, some troughs or hollows (k̂ are provided on the cylinder Q), in which the protuberances (V) of the disks (18) are fastened in an elastic manner or by pressing. It is preferable that the protuberances (V) of the disks (18) are inclined in the pre-closing area (pa!). For stiffening, in case of more disks (18) these can couple two or more by connecting links (n[) provided with holes (&). The upper inner cylinder head (7) has the diameter correlated with the inner diameter of the inner cylinder (Y), in order to enter pressed in this. The fastening of the upper inner cylinder head (7) in the inner cylinder (Y) is made by pressing/binding. In order to improve the fastening by binding, the surfaces in contact of the inner cylinder (Y) and of the upper inner cylinder head (T), are processed for the creation of the rugosity and preferably, by making some circular mini-troughs (p″″″), so that the protuberances of a part gets into the dimples of the other one.

FIG. 82. The troughs shape and the steps are chosen so that to facilitate the auto setting and to avoid the wrong troughs overlap.

The piston rod (5) passes through the boring (g£) of the piston (4), against to which is fastened in a radial manner. The axial fastening of the piston (4), to the piston rod (5), is made between the collar (£) of the piston rod (5) and the head (b″″″), formed by heat flanging of the lower end of the piston rod. (S). In order to facilitate the flanging of the head (b″″″), the boring (g\ddot{υ}), is conic on the lower side (c″″″). We recommend the indentations (i″″″), from the flanged head should be horizontal or inclined so that the gas/vapor lock is not formed, their level being, for this purpose, under the level of the lower surface (cT), of the piston (4).

Lower, the inner cylinder (Y) is fastened on the protuberance (k) of the bottom outer lid (12), through a fastening hub (14), towards which it is fastened/aligned on its surfaces (u).

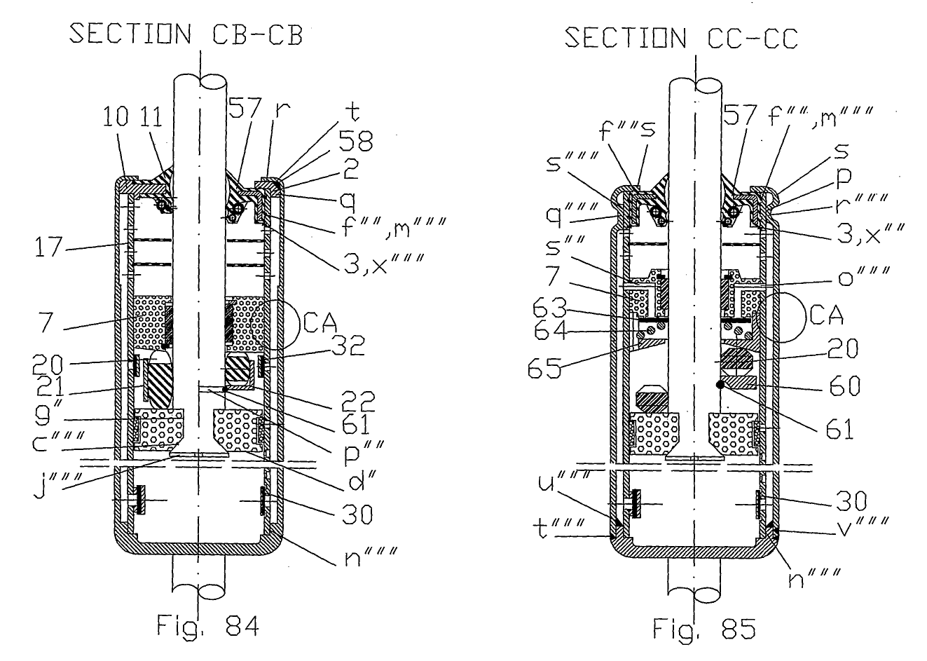

Automotive self-adjustable shock absorber with self-correcting damping characteristic, having curved, cylindrical and planar filling valves according to the nineteenth accomplishing example—FIG. 84 is shown in the single guide variant, seal by removable joint (57), or seal member (11) applied on the outer lid (52), rebound stopper bumper (20) with limiting casing (21), on the piston (4), or stopper bumper (20) in cup hanger (22), fastened on the piston rod (1), through the safety ring (61), filling on compression with the inner curved/cylindrical valve (32), placed on the upper side of the inner cylinder (1), filling on rebound with the inner curved/cylindrical valve (30), placed on the lower side of the inner cylinder (1) and the piston (4), fastened by flange on the piston rod (5).

The removable seal member (57) is directly fastened in the inner cylinder (1), at the upper end of this, provided with some circular borings (m″″″), with need shape, in which the protuberances (F″) get. In order to make a most secure fastening we recommend using a safety ring (3) fastened on the trough (x″″″).

The fastening/aligning of the inner cylinder (V), against the outer cylinder (6), is made on the upper side through the annular lid (2), with section having “L” shape, the vertical crown (g) ensuring the radial fastening to the inner surface (g), machined/not machined, of the outer cylinder (6), and, the horizontal crown (r), the axial fastening with the closing rim (s), of the outer cylinder (6).

The fastening/alignment of the inner cylinder Q), to the outer cylinder (6), is made on the lower side through the collar (n″″″), placed in the bottom outer lid (12), the collar being aligned to the inner surface (g), machined/not machined, of the outer cylinder (6).

Automotive self-adjustable shock absorber with self-correcting damping characteristic, having curved, cylindrical and planar filling valves according to the twentieth accomplishing example—FIG. 85 is shown in the single guide variant, seal by removable joint (57), rebound stopper bumper (20), on the piston (4), or stopper bumper (20), on the annular hanger (60), fastened on the piston rod (Y), through the safety ring (61), filling on compression with the upper planar valve formed from the upper inner cylinder head (7), the annular plate (63), the spiral spring (64) and a cup (65), placed on the upper side of the inner cylinder (Y), filling on rebound with the inner curved/cylindrical valve (30), placed on the lower side of the inner cylinder Q) and the piston (4), fastened by flanging on the piston rod (5).

The upper inner cylinder head (T), and the cup (65), are fastened in the inner cylinder (Y), by pressing/binding, purpose in which recommends that contact surfaces be machined with fine mini-troughs (p″″″).

For the access of oil in the inner cylinder (Y), borings (o″″″), in correspondence with the borings (s″″), from the upper inner cylinder head (T), are provided.

The removable gasket (57), is fastened directly in the inner cylinder (V), on the upper end of it, provided with circular borings (m), having the desired shape, in which the protuberances (f″) fasten. For a strong fastening a safety ring (3), introduced in a circular trough (x″″″) is provided.

The fastening/centering of the inner cylinder (I), against to the outer cylinder (6), is made in the upper area, axially with the rim (s) and radial with the longitudinal indentation (q″″″)5 or with the annular collar (r″″″), which have the inner surfaces Cs″″″) processed in order to rigid with the inner cylinder (1), and in the lower part by the collar (n.″″″), placed in the bottom outer lid (12).

The longitudinal indentation (q″″″) can be extended downward for the stiffening and improvement of the cooling, when their inner surfaces (s″″″) are partially processed on the entire surface for fastening with the inner cylinder (V).

The assembling of the bottom outer lid (12) is made by the outer (t″″″> and inner (u″″″) solder cordons, and/or by solder in tabs (v″″″).

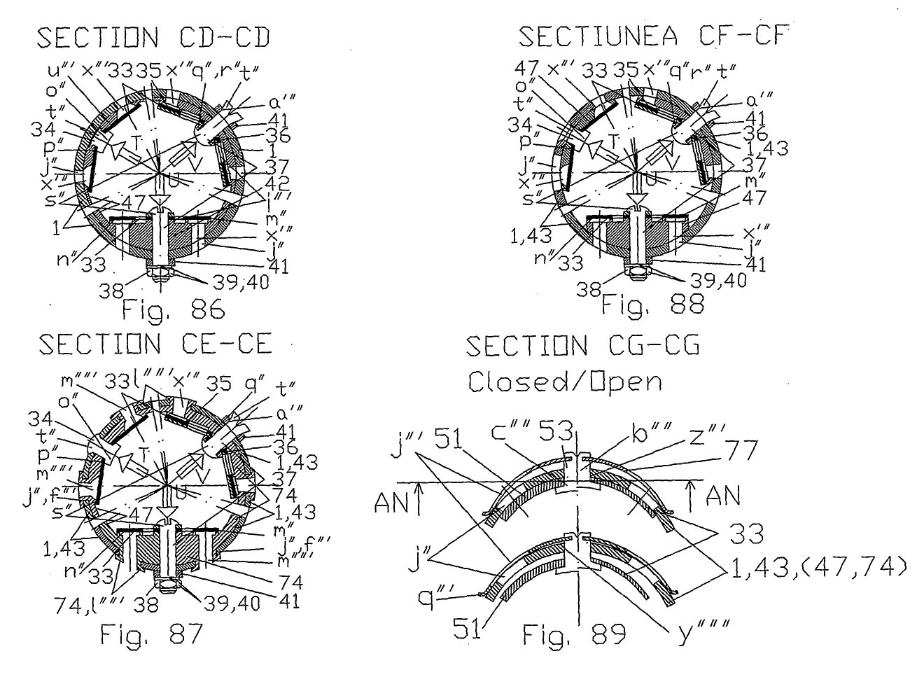

Automotive self-adjustable shock absorber with self-correcting damping characteristic, having curved, cylindrical and planar filling valves according to the twenty-first accomplishing example—FIG. 86, show variant of the valve on the inner annular body (46), placed inside the inner cylinder (V), with planar surfaces Of″), respectively prominences (i), for plates (33),

(35) setting. The solutions are identical with those valid for the variant with' curved/cylindrical setting surfaces, the areas T, U, V showing the plates setting surfaces:

in the T view: directly on the inner planar surfaces (u′″), of the inner annular body (47), placed inside the inner cylinder (V);

in the U view: on the inner planar prominences (f″), of the annular body (47), remained prominent by erosion of the neighbor surfaces, the annular body (47) placed inside the inner cylinder (V);

in the V view: on the inner planar prominences (i′″), of the annular body (47), resulted by addition of material, the annular body (47) placed inside the inner cylinder (V);

The surfaces (u′″) and prominences (i′″) can have a curved/cylindrical/planar shape and the plates will have the surfaces correlated with these.

Automotive self-adjustable shock absorber with self-correcting damping characteristic, having curved, cylindrical and planar filling valves according to the twenty-second accomplishing example—FIG. 87, show the valve

in the T view: directly on the inner planar surfaces (u′″), of the cast inner annular body (74), placed inside the inner cylinder (V);

in the U view: on the inner planar prominences (i′″), of the cast inner annular body (74), remained prominent by erosion of the neighbor surfaces, the annular body (74) placed inside the inner cylinder (V);

in the V view: on the inner planar prominences (i′″), of the cast annular body (74), resulted by addition of material, the annular body (74) placed inside the inner cylinder (V);

The existence of the fastening collars (!′″″) allows the using also as annular segments valves

The surfaces fa′″) and prominences (T″) can have a curved/cylindrical/planar shape and the plates will have the surfaces correlated with these.

Automotive self-adjustable shock absorber with self-correcting damping characteristic, having curved, cylindrical and planar filling valves according to the twenty-third accomplishing example—FIG. 88, show variant of title valve on the inner annular body (46) arcs, placed inside the inner cylinder Q), or inside the annular cover (43), with the planar surfaces (u′″), respectively prominences (i), for plates (33), (35) setting. The solutions are identical with previous variants with planar/curved/cylindrical setting surfaces, the differences being that every valve is placed on an arch of inner annular body, every arc fastened on the inner cylinder (1), or on the inner annular body (47). The areas T, U, V show the plates setting surfaces:

in the T view: directly on the inner planar surfaces (u′″), of the inner annular body (47) arc, placed inside the inner cylinder (Y); in the U view: on the inner planar prominences (T″). of the annular body (47) arc, remained prominent by erosion of the neighbor surfaces, the annular body arc (47) placed inside the inner cylinder (Y);

in the V view: on the inner planar prominences (i′″)>> of the annular body (47) arc, resulted by addition of material, the annular body (47) placed inside the inner cylinder (Y);

The surfaces (u′″) and prominences (i′″) can have a curved/cylindrical/planar shape and the plates will have the surfaces correlated with these.

Automotive self-adjustable shock absorber with self-correcting damping characteristic, having curved, cylindrical and planar filling valves according to the twenty-fourth accomplishing example—FIG. 89, shows the solution of curved filling valve, with rigid/semi rigid/elastic plates, with outer plate spring. It is made up of a rigid/semi rigid/elastic plate (51)/(33), placed inside the inner cylinder (Y), or of the inner annular body (47), or of the annular cover (43), or of the injected/cast annular body (74), directly, or on protuberances (P″), covering or not the holes (fj) for oil penetration. The plate rigid/semi rigid (51), or elastic (33), are fastened on the rivet/screw (53) through the hole (z′″\ both having a rectangular or oval section so that the rotation is not allowed. The rivet/screw (53) glides in the boring (y″″″), of inner cylinder (1)/annular cover (43)/annular body (47)/cast/injected annular body (74), controlled by the spring plate (77), fastened at its end by riveting or nut. In order to allow the liquid access, the spring arms have borings/slots (f″).

The surfaces (u′″) and prominences (i′″) can have a curved/cylindrical/planar shape and the plates will have the surfaces correlated with these.

1. Automotive self-adjustable shock absorber with self-correcting damping characteristic, having curved, cylindrical and planar filling valves comprising:
an inner cylinder (1) forming a working chamber (a), the inner cylinder (Y) being provided along the length thereof with a plurality of rebound damping metering holes/slots (al) and compression damping metering holes/slots (V).
a piston (4) slidably mounted within the working chamber (a) and separating the working chamber (a) into a rebound compartment (b) and a compression compartment (c), the volumes of which vary in accordance with the piston (4) position, in the working chamber (a);
a piston rod (5) connected to the piston (4) and extended for the end of the working chamber (a) adjacent to the rebound chamber (b) moves piston (4) inside the working chamber (a);
an outer cylinder (6) disposed around the inner cylinder (1), the outer cylinder (6) forming a reservoir chamber (d), between the inner cylinder (1) and the outer cylinder (C) an inner cylinder head (T), of the inner cylinder (Y) closing the end of the working chamber (a) adjacent the rebound compartment (b), the inner cylinder head (T) being provided with an annular piston rod guide (8) or a central aperture (e), being sized to slidably engage around the piston rod (5) and with a collar (f) rigid with the inner wall of the outer cylinder (6);
an outer upper lid (10) provided with a seal member (11), having a central aperture (j), sized to slidably engage around the piston rod (5);
a labyrinth system (9) with passages (g) for working liquid passing, sustained by the upper part of the inner cylinder head (7), and upper limited with an outer upper lid (10), the compartment between the inner cylinder head (T), of the inner cylinder (Y), the outer upper lid (10), piston rod (5) and outer cylinder (6) forming a balance chamber (h);
a fluid fills the working chamber (a) and at least partially fills the balance chamber (h);
some slots or Holes® in the collar (f) of the inner cylinder head (T) ensure the oil passing between the balance chamber (K) and the reservoir chamber (d);
a plurality of rebound filling valves (30), at the lower end of the inner cylinder (Y);
a plurality of compression filling valves (32), at the upper end of the inner cylinder (Y);
a plurality of rebound and compression filling valves (31), are provided on the inner cylinder (1) between the rebound filling valves (30) and the compression filling valves Q2);
characterized in that: inside, the bottom outer lid (12) has a prominence (k) with a face (1) which is flat, tapered or spherically processed, for the location-alignment of the inner cylinder (Y), through a fastening hub (14) of metallic, plastic, elastic or elastic-plastic, easy deformable material, for improving the seal-centering, the fastening hub (14) covering inside and/or outside the lower extremity of the inner cylinder (Y), the fastening hub (14) having the inner faces (n) for the location of the inner cylinder (Y) and the face (o) for its location on the prominence (k), with forms correlated to the forms of the mating members, its lower face (m) being processed in correlation with the face (V) of the prominence (k);
the outer surface (g) of the outer upper lid (10) and the inner upper area (p) of the outer cylinder (6), are preferably machined, in order to achieve the alignment of the assembly formed by the inner cylinder (V), the upper inner cylinder head (T), the balance chamber cylinder (17), the outer upper lid (10), with the face (Y) from the prominence (k) from the lower side of the bottom outer lid (12). the outer upper lid (10) has the annular edge (cQ rigid with the outer cylinder (6) in the upper processed area (p) being axially fixed through the face (r) with a rimed edge (s) of the upper end of the outer cylinder (6), the closing flanging (s) being allowed by the dull (t) machined in the outer upper lid (10);
the slidably seal member (11) of the piston rod (5) has two extensions, the upper one (u) and the lower one (V) that covers the outer upper lid (10) being fixed on it;
the seal of the outer upper lid (10) is done relative to the outer cylinder (6) through the upper extension (u) of the slidably seal member (VV) of the piston rod (5), which towards its extremity has preferably an annular prominence (W) with a convenient section, which is deformed at the molding (s) of the outer cylinder, so providing the contact pressure necessary for the seal at the top pressure;
the opening 0 of the seal member (11) is provided with three lips (x), (y), (z), that confines an upper chamber (Jk″″″) and a lower one (!″″″), behind the lower chamber (!″″″) there is an annular trough (<£) which a ring spring (15) is introduced in order to increase the tightening force of the lips (y), (z), the calibration of the lower lip (z) being carried out through a dull surface (d′), a second annular trough (e′), which a second ring spring (16) is introduced, is provided for the seal at high pressures;
at the bottom of the outer upper lid (10) a centering collar (f) positioning the system of labyrinths (9) radial;
the system of labyrinths (9) is formed by a cylinder (17) with orifices (g) for the liquid passing and from some disks (18) provided with the communication orifices (g), the disks (18) being fixed on the exterior and/or on the interior of the cylinder (17), the fastening can be a rigid one, by pressing or by weld, or by form, at the fastening by pressing the disks have an edge Qf) provided with some orifices (T) or trough (j′), in order to improve the cupping, and for fastening by form, on the cylinder (17) there are some troughs or hollows (k_0 where the prominences (V) are fastened elastically or by molding/pressing, preferably inclined in the pre-terminal area (m′), and in the case of several disks (18), two or more can be coupled by connecting links (nl) provided with orifices (oj);
the upper inner cylinder head (T) is provided in the aperture (pi) for introducing of the guide with a tab (cf) and an annular trough (f) where a safety ring (19) is introduced, the tab (g£) can be placed either at the upper extremity, or at the lower extremity of the upper inner cylinder head (T);
it is provided with a rebound stopper bumper (20) with planar or profiled upper (s′) and lower (f) faces, the section of the stopper bumper having a shape correlated with the desired elastic characteristic, the stopper bumper being placed on the piston (4), around the piston rod (5) or on a annular hanger (60), or it is introduced into a cup hanger (22), fixed on the piston rod (5) by a tab (y2), or by a safety ring (61) the height of the stopper bumper (20) being bigger than the depth of the cup, the stopper bumper (20) placed on the piston being provided with a rigid (metallic) limiting casing (21) less higher than the stopper bumper (20) so that the stopper bumper (20) can get out on both sides of the limiting casing (21), the maintaining of the relative position of the limiting casing (21), towards the stopper bumper (20), is made either by sticking the stopper bumper (20) on the limiting casing (21), or by a trough (u′) or by many orifices (V) carried out in the limiting casing (21) where the material of the stopper (2Q) enters, or the stopper bumper and the limiting casing are mono-body cast;
the upper inner cylinder head (7) and the piston (4) will have the contact faces of the stopper bumper (w′), QO horizontal or conical, inclined upwards or downwards, correlated with the elastic characteristic and the ventilation;
in the cylindrical area the piston (4) is provided with one or more annular troughs (V) where one or more segments (23) are introduced, with the slot (a″) cut like a zigzag with right edges, having one or more steps (b″);
the fastening of the piston (4) on the piston rod (5) is done axially in the upper area, through a tab (c″) of the piston rod (S), and in the lower area with an auto locking collar nut (24) on a flat washer (25) or with the common nut (26) a Grower washer (27) and a flat washer (28) applied directly on the lower face (d″) of the piston (4) or on a milling (e″), carried out in the lower face of the piston (4), the nuts being fixed on a thread (F) at the lower end of the piston rod (S), the radial fastening of the piston (4) on the piston rod (S), being achieved through an aperture (g″) carried out in the central area of the piston;
there is a cutting (a″″″) inside the piston, or some cavities (ĥ of a convenient shape, closed by a lid (29), sustained on the bottom cavity, or inside a tab (F);
the inner rebound (30) and compression (32) filling valves are formed by a curved/cylindrical plate (33), placed on the inner face (V̂, of the inner cylinder (1) or on some prominences (F′), as a result of material addition or cutting (y′″) on/from the setting surfaces (vfO, the plate (33), being fixed, by a rivet or by screw with profiled head (34), its body passing through a boring QO carried out in the wall of the inner cylinder (Y) and an aperture (F) carried out in the plate (33), in order to avoid rotation we can use either more rivets or more screws with profiled heads (34) placed on the generator of the inner cylinder (Y), or in a normal plane on the radial axis of the cylinder or after parallel axes, either rivets/screws or hub that cover the rivet/screw, with a section different from the round one (square, rectangular or some other shape), the number and the shape of the borings Q̂), (F) being correlated with the number and the shape of the fastening element with profiled head (34);
the plate (33) has one or two symmetrical or asymmetrical arms (m″), (iF), their extremities covering the orifices (FJ carried out in the inner cylinder Q);
the plate (33) can be reinforced with one or more elastic identical or different additional plates (35), located inside, over the plate (33), the plate/s (33)7(35) being fixed on the inner wall of the inner cylinder (Y), either directly through the profiled head (ĝ) of the rivet/rivets with profiled head (34), or of the screw/screws with profiled head (34), when their setting surface dO, on the plate has the width and the shape of the plates, either through the hub for inner head (36), with the face (cø, towards the plate shaped in correlation with the width and the shape of the plate and the face (r̂), towards the head (sT) of the rivet/screw with planar head (37) correlated or not-hub (42) with their face (flat, conical) for the rivet/screw with planar buried head (37), the boring (̂) having the side (a′″), towards the head (F), conically shaped, correlated with the shape of live head (F), of the rivet/screw with planar head (37);
outside the rivet/the screw (34)/(37) are fixed with an exterior head (F), with a self-locking nut respectively (38), or a common nut (39) and the Grower washer (40), the exterior head (F), of the rivet (34)7(37), the nut (38), the Grower washer (40), and the nut (39), being placed directly on the inner cylinder (V), but preferably on a planished surface (vT), in the cylinder (V), or on a hub (41) that has the face (w″) in contact with the exterior rivet/screw head (34)7(37), or with the nut (38). the Grower washer (40), and the planar nut (39), and the cylindrical face (x̂), in contact with the inner cylinder (V), with the diameter correlated with that of the inner cylinder Q). the borings (£)I(̂D, carried out in the hubs (36)/(41)/(42). for the passing of the rivet/screw body (34)/(37), having the shape in correlation with the shape of the rivet/screw (M)/(37), and the boring Qø from the cylinder Q), and the boring (£) from the hub (41), being conical in the end area (a′″) towards the head of the rivet;
the outer filling valves (31), with the construction similar to the inner rebound filling valves (30) and compression filling valves (32), with the difference that at the outer ones (31), the curved/cylindrical plate/plates (33), (35) are placed on the cylindrical inner face (b′″), or on some prominences (f″), resulted from material addition or cutting (y′″) on/from the setting surfaces (b′″), on the side body (c′″) of an annular cover (43), its annular tabs (d′″), covering one or more orifices (£) and being fixed and sealed on the exterior of the inner cylinder (V), the inner faces of the side body (c′″) and of the annular tabs (d′″) of the annular cover (43) forming together with the exterior surface (g′″) of the inner cylinder (V), an toroidal enclosure (e′″), in the side body (c′″) of the annular cover (43), towards the extremities of the arms (m″), (x£) of title curved/cylindrical plate (33), (35), some orifices or slots (f″) are carried out, the fixation of the curved/cylindrical plate (33), (35), being done by the rivet/screw (34), (37), its body passes through a boring (h′″) carried out in the side body (c′″) of the annular cover (43) and the boring (T) carried out in the plates (33), (35);
the curved/cylindrical plates (33), (35) have, in their arms (m?), (£), slots (£1), filleted Cn′″), at endings, the channels can be symmetrical or asymmetrical and they form one or more arms (k′″) that link the fixation area (T″), with the sealing area of the plates (m′″), and one or more tongues (o_\ddot{υ}l), preferably starting under the profiled head (o″), of the rivet/screw (34), or under the hub of the inner head (36), for reinforcing the tongues (o′″), can be united at the top, or inside through a linking element (p′″) of a convenient shape, the tongues (o′″) are inflected/rimed (q′″), at ends, in order to slip on the plate, the tongues of the plates (33), (35), being correlated, in order to run over the sealing area (m′″), the plates (33), (35), can be identical but in a rotated position;
a tin layer (44), or another moldable material is applied on the whole surface plates valves setting;
the metering holes/slots (al), (V)5 can be achieved directly or in steps, according to the used technology;
in the inner cylinder (V), on the technological holes (r′″), or on the mistaken metering holes (f″), there is located one of the metering holes (s′″) carried out in the annular body (45), correcting the adjustment, and when the obstructing of the metering hole (s′″) is desired, it is located displacement in comparison to the orifices (r′″)/(f″), or (s′″) orifices are missed;
the prominences (i′″) can have a curved/cylindrical/planar shape and the plates will have the surfaces correlated with these.

2. Automotive self-adjustable shock absorber with self-correcting damping characteristic, having curved, cylindrical and planar filling valves, according to the claim 1, characterized in that: for filling it uses one or more rebound and/or compression filling valves (46), on the inner annular body formed by the symmetric or asymmetric curved/cylindrical/planar plate (33) setting directly on the inner curved/cylindrical/planar face (u′″), of the annular body (47) or on the curved/cylindrical/planar prominences (T″) applied on the inner surface (û), or on curved/cylindrical/planar prominences (T″), resulting from the cutting of some troughs (y′″) in the inner surface (u′″). of the annular body (47) and one or more curved/cylindrical/planar, additional symmetrical or asymmetrical plates (35), located on the plate (33);
the annular body (47) is rigidly and tightly inside the inner cylinder (1), or inside the annular cover (43). the inner annular body (47) having the outer face (v′″) machined in correlation with the inner face of the inner cylinder (Y), or (b′″) of the annular cover (43);
the fastening of the plates (33), (35) is done through the rivet/screw (34)/(37), passing through the aperture (P), from the plates (33), (35) and the boring (w3″), from the inner annular body (42);
the rivet/screw (34)/(37), either has the endings (Jf)5 (l\ddot{υ}λ buried in the annular body (47) in order to avoid the exceeding of the inner diameter of the inner cylinder (1), or of the annular cover (43), or it passes through a boring (k″), carried out in the inner cylinder (Y), (bT) respectively, carried out in the annular cover (43), being fixed on their exterior using one of the previous procedures, used for the inner valves (30), (32), or at the outer valves (31);
for the fluid access in the inner annular body (47), under the arms (m″), (j£), of the plates (33), some borings (x′″), are carried out, corresponding to the borings (j\ddot{υ}) from the inner cylinder (D>> (?″) respectively, in the annular cover (43);
when the screw/rivet (34)/(37) head setting, is done directly on the outer face (v″^{o}, of the inner annular body (47), or on the exterior of the inner cylinder (I)5 or on the annular cover (43), depending on the fastening element, at the ending of the borings (w′″)/(k″)/(li″), for rivet/screw (34)/(37) passing, a planished surface (uQ, or a conical boring (a) is machined;
when the rivet/screw (34)/(37), passes through the inner cylinder (1), or the annular cover (43), the inner annular body (47) can be replaced by one or more arcs of annular body containing fastening elements and valves;
the surfaces (b′″)/(u′″), of the annular cover (43)/of the inner annular body (47) and the prominences (f″) can have a curved/cylindrical/planar shape and the plates will have the surfaces correlated with these.

3. Automotive self-adjustable shock absorber with self-correcting damping characteristic, having curved, cylindrical and planar filling valves, according to the claim 1 or 2, characterized in that: for the filling at rebound and/or compression it uses one or more inner filling valves (30)/(32) located on the inner cylinder (1), and/or one or more filling valves (46) on the inner annular body and/or one or more outer filling valves (31), formed by the symmetric or asymmetric, three arm plate (48) and eventually one or more additional symmetric or asymmetric, three arm plates (49) located overlap the plate (48);
the plate (48) is located at the inner valves (30), (32) on the inner face (O of the inner cylinder (Y), at the outer valves (31) on the inner face (b) of the annular cover (43), respectively at the valves on the inner annular body (46), on the inner face (u′″\ of the inner bushing (47) or on the prominences (i′″), as a result of material addition or cutting;
the plates (48), (49), are fixed by the rivet/screw (34), (37), that passes through the aperture (T), from the plates (48), (49), and the borings QO from the inner cylinder (Y), to the inner valves (30), (32), through the aperture (h′″), to the outer valves (31) and through the boring (w′″), eventually (k″), at the valves on the inner annular body (46);
the filling holes (£), from the inner cylinder (1), at the inner filling valves (30), (32), respectively the filling holes (f″) from the annular cover (43), at the outer filling valves (31), respectively the filling holes (x′″), on the inner annular body (47), at the valves on the inner annular body (46), are placed symmetrically or asymmetrically relative the fastening holes (kf) of the plates (48)/(49);
in the arms (wT), (x£) of the plates (48), (49), some slots (£1), form the arms QO and if necessary, some tongues (o′″), that are provided with an inflection/rim (q′″) at the ending, the tongues (o′″), being profiled in such a way as to be located on the sealing area (m′″), of the plate (48), for the one plate solution, and the last plate (49), for the several plates solution, respectively. the surfaces (b′″)/(u′″), of the annular cover (43)/of the inner annular body (47) and the prominences (i′″) can have a curved/cylindrical/planar shape and the plates will have the surfaces correlated with these.

4. Automotive self-adjustable shock absorber with self-correcting damping characteristic, having curved, cylindrical and planar filling valves, according to one of the claims 1 to 3, characterized in that: for the filling at rebound and/or compression it uses one or more inner filling valves (30)/(32) located on the inner cylinder (1), and/or one or more filling valves (46) on the inner annular body and/or one or more outer filling valves (31), formed by the symmetric or asymmetric, two arm plates (33) and eventually one or more additional symmetric or asymmetric, two arm plates (35) on which there is a spring plate (50), with one or two symmetric or asymmetric arms, that have a fastening area (V″), that is continued with two tongues (o′″), finished by an inflection/rim (q′″), that setting over the sealing area (m′″), of the plates (33), for the one plate version and on the last plate (35), respectively, for the several plates version;
the rivet/the screw (34)/(37), passes through the apertures (P) of the plates (33), (35), the borings (j£!) from the inner cylinder (1), at the inner valves (30), (32), through the boring (h′″) at the outer valves (31), and through the boring (w′″) at the valves on the inner annular body (46) and it is tightened between the face (p̂) of the profiled head (cT), or the face (c£) of the hub (36) for the inner head, and the inner face (v″), of the inner cylinder (I)5 at the inner valves (30), (32), respectively the face fb′″) of the annular cover (43), at the outer valves (31), respectively the face (u′″)/(v″), of the inner annular body (47)/of the inner cylinder (1), at the valves (46) on the inner annular body;
the plate (33) setting can be done directly on the inner curved/cylindrical surface (v″)/(b′″)/(u′″), of the inner cylinder (V)M the annular cover (43)/of the inner annular body (47), at the inner valves (30), (32)/the outer valves (31)/the valves on the inner annular body (46), or on the prominences (i) applied on the inner surface, or as a result of material cutting (y), from the inner curbed/cylindrical surface (v″)/(b′″)/(u′″), of the inner cylinder (I)/of the annular cover (43)/of the inner annular body (47) at the inner valves (30), (32)/the outer valves (31)/the valves on the inner annular body (46);
the surfaces (b′″V(u′″), of the annular cover (43)/of the inner annular body (47) and the prominences Cf) can have a curved/cylindrical/planar shape and the plates will have the surfaces correlated with these.

5. Automotive self-adjustable shock absorber with self-correcting damping characteristic, having curved, cylindrical and planar filling valves, according to one of the claims 1 to 4,
characterized in that: for the filling at rebound and/or compression it uses one or more inner filling valves (30)/(32) located on the inner cylinder (Y), and/or one or more filling valves on the inner annular body (46) and/or one or more outer filling valves (31), formed by the rigid or semi rigid/elastic plate (51)/(33), that is pressed on the holes for the oil penetration, by a spring plate (50);
the plates (51)/(33), (50) have a guiding area (F), continued by two arms (m″), (n″), in the centre of the guiding area (T) one or more borings (z′″) in the plates (51)/(33), respectively (a″″) in the plate (50), are carried out, through which the rivet/the screw (53) with head and profiled body passes;
when a single rivet/screw (53), is used, its body in the guiding area (c″″), and the borings (z′″),
(a″″), have a non-circular shape (square, rectangular, oval, star-shaped) in order to impede the rotation, when more rivets/screws (53) are used, the guiding area (c), the borings (ẑl), (a″″), respectively, can be circular;
the dimensions of the borings (z′″), (a″″), are so, as to ensure the sliding of the plates f51)7(33), (50) on the guiding area (c″″), of the rivet/screw (53), and the guiding area (c″″), of the rivet/screw (53), is longer than the sum of the plates (51)/(33), (50) thickness;
in the ending area the rivet/screw (53), has a tab fb″″), with which it is fixed in the boring (kfl), from the inner cylinder (Y), at the inner valves (30), (32), in the boring (h′″) respectively, from the annular cover (43), at the outer valves (31), in the boring (w′″) respectively, from the inner annular boy (47), at the valves on the inner annular body;
for the relief and when one desired the plate (51) to operate in an elastic manner, in the arms (m″), (r£), troughs of desired form are made;
the fastening of the rivet/screw (53) outside, is done through riveting/nut in the same way as the previous solutions on the inner valves (30), (32), outer valves (31), or valves on the inner annular body (46);
the location of the plate (51)7(33) can be done directly on the inner curved/cylindrical surface (v″)/(b′″)/(u′″), of the inner cylinder (1)/of the annular cover (43)/of the inner annular body (47), at the inner valves (30), (32)/the outer valves (31)/the valves on the inner annular body (46), or on the applied prominences (F″) or on the prominences (iw>) as a result of material (y) cutting, from the inner curved/cylindrical surface (v″)/(b′″)/(u′″), of the inner cylinder (1)/of the annular cover (43)/of the inner annular body (47) at the inner valves (30), (32)/the outer valves (31)/the valves on the inner annular body (46);
the surfaces (b′″)/(u′″), of the annular cover (43)/of the inner annular body (47) and the prominences (i′″) can have a curved/cylindrical/planar shape and the plates will have the surfaces correlated with these.

6. Automotive self-adjustable shock absorber with self-correcting damping characteristic, having curved, cylindrical and planar filling valves, according to one of the claims 1 to 5, characterized in that: for the filling at rebound and/or compression it uses one or more inner filling valves (30)/(32) located on the inner cylinder (Y), and/or one or more filling valves on the inner annular body (46) and/or one or more outer filling valves (31), formed by the rigid or semi rigid plate (51)/elastic plate (33), that is pressed on the holes for the oil penetration, by a press beam (54), acted by a spiral spring (55), that is supported by the profiled head (ô), of the rivet/screw (56), the press beam (54), being provided with one or more borings (d″″) in the central area, for sliding on the area (c″″) of the rivet/screw (56);
the plate (51)/(33), has a guiding area (T), continued by two arms (m″), (n\ddot{υ}), in the center of the guiding area (P), the plate (51)/(33), being carried out one or more borings (z′″), through which the rivet/screw (56) with profiled head and body passes, when a single rivet/screw (56) is used, its body in the guiding area (c″″), and the borings (z′″),
(d″″), have a non-circular shape (square, rectangular, oval, star-shaped) in order to impede the rotation, when more rivets/screws (56) are used, the guiding area (c″″), the borings (z′″), (d″″), respectively, can be circular;
the number of the spiral springs (55), and the length, of the guiding area (c″″), are correlated to the number of rivets/screws (56) and the desired elastic characteristic, the shape and the dimensions of the borings (z′″*h (d″″), being so, as to ensure the sliding of the plate (5_l)/(33) and of the press beam (54) on the guiding area (c″″), of the rivet/screw (56);
in the ending area the rivet/screw (56), has a tab (b), with which it is fixed in the boring (̂), from the inner cylinder (Y), at the inner valves (30), (32), in the boring (Ia′″) respectively, from the annular cover (43), at the outer valves (31), in the boring (w″̂ respectively, from the inner annular body (47), at the valves on the inner annular body (46);
the guiding area (c″″), of the rivet/screw (56), is longer than the sum of the thickness of the plate (51)/(33), of the press beam (54) and of the coils of the spring (55);
the fastening of the rivet/screw (56), outside, is done through riveting/nut in the same way as the previous solutions on the inner valves (30), (32), outer valves (31), or valves on the inner annular body (46);
the press beam (54) can miss, and in this case it is recommendable that the setting surface of the spring (55), on the plate (51)/(33), to be shaped accordingly;
in order to be easier and when it is desired that the plate (51) run elastically, some slots (f″) of a desired shape are carried out in the arms (m″) (n″);
the location of the plate (51)7(33), can be done directly on the inner curved/cylindrical surface (v″)/(b′″)/(u′″), of the inner cylinder (I)/of the annular cover (43)/of the inner annular body (47) at the inner valves (30), (32)/the outer valves (31)/the valves on the inner annular body (46), or on the prominences (i′″) applied on the inner surface, or on the prominences (P″) as a result of material (y′″) cutting, from the curved/cylindrical surface (y″)/(b′″)/(u′″), of the inner cylinder (1)/of the annular cover (43)/of the inner annular body (47) at the inner valves (30), (32)/the outer valves (31)/the valves on the inner annular body (46);
the surfaces (b′″)/(u′″), of the annular cover (43)/of the inner annular body (47) and the prominences (i′″) can have a curved/cylindrical/planar shape and the plates will have the surfaces correlated with these.

7. Automotive self-adjustable shock absorber with self-correcting damping characteristic, having curved, cylindrical and planar filling valves, according to one of the claims 1 to 6, characterized in that: it has the slide seal of the piston rod (S), achieved by a gasket (57), fixed in an aperture (e″″), of the outer upper lid (10), the seal of the outer upper lid (10), being done relative to the outer cylinder (6), through a ring gasket (58), O type, introduced into a circular dull φ, carried out in the outer upper lid (10) compressed through the closing flange (s), of the outer cylinder (6);
the opening (j) of the seal member (57) is provided with three lips (x), (y), (z) confining two chambers (k″″″), (!″″″), behind the lower chamber (!″″″) there is a circular trough (d) where a ring spring (15) is introduced and a second circular trough (§0 where the second ring spring is introduced (16), the calibration of the lower lip (z), being done through a dull edge (dj);
the strength of the gasket (57) is ensured by an inner reinforcement (59);
there are some circular prominences (P″) of convenient section on the side face and the front faces;
the aperture (e″″) can be applied at the upper or lower part of the outer upper lid (10), so the confine collar (g) of the gasket (57) may be placed upper or lower part;
the aperture (e″″) has some circular troughs (m″″″) where the prominences (P″) are fixed/sealed.

8. Automotive self-adjustable shock absorber with self-correcting damping characteristic, having curved, cylindrical and planar filling valves, according to one of the claims 1 to 7, characterized in that: the lower part (w′) of the upper inner cylinder head (7) is continued by a circular extension (h″″) with a lower diameter in comparison with that of the inner cylinder (1);
a circular recess (i″″), in which the rebound stopper bumper (20), enters totally or partly, is carried out in the upper face (x̂) of the piston (4), the diameter of the cupping (i) being bigger than that of the extension (h″″);

9. Automotive self-adjustable shock absorber with self-correcting damping characteristic, having curved, cylindrical and planar filling valves, according to one of the claims 1 to 8, characterized in that: the outer upper lid QO) is provided in the central area with a circular opening (e) slidably adjusted with the piston rod (5), or a recess (pj), where an additional guide (8), is introduced slidably adjusted with the piston rod (5), the guide being limited axially by a tab (c£) and by the safety ring (19) eventually, fixed in a trough (f);
in the top area of the outer upper lid (10), there is a central aperture (e″″), that has some circular troughs (m″″″), in the aperture (e), there is introduced a gasket (57), provided with some circular, with convenient section prominences (P″) that are fixed/sealed in the troughs
(m″″″), the recess being axially limited by the tab (g″″);
the fastening of the upper outer upper lid (10) against the outer cylinder (6), is radially done through the tab (g), rigidly placed on the machined area (p_), of the outer cylinder (6) and axially through the edge (s), of the outer cylinder (6);
the fastening of the upper outer upper lid (10) against the inner cylinder (Y), is done through the tab (f);
the sealing of the upper outer upper lid (10), at the outer lid (6), is achieved by a circular gasket (58), placed in the circular dull (t);
an enclosure (f'), collects the oil rabbled out by the gasket, that is sent back in the reservoir chamber (d), through a boring (k″″). some millings (o″″) are provided on the side face of the outer upper lid (10) for weight reducing and material economy

10. Automotive self-adjustable shock absorber with self-correcting damping characteristic, having curved, cylindrical and planar filling valves, according to one of the claims 1 to 9, characterized in that: the central aperture (“e″”), of the outer upper lid (10), is increased and receives a Hd (52), with the slide gasket (11) of the piston rod and with an upper extension (u) of the gasket up to the end of the outer upper lid (10), the extension (u) being provided with a circular prominence (W);
the fastening of the outer upper lid (10) against the inner cylinder (V), is done through the flange (s), of the outer cylinder (6);
the gasket has all the previous defined elements and in addition it has a circular tongue (T′″), that is supported on a prominence (m″″), of the outer upper lid (10), defining the enclosure (n″″), that communicates with the reservoir chamber (d), through the exhaust hole (Ic″″), impeding the penetration of the oil from the reservoir chamber (d) in the enclosure (n″″), but making possible the discharge of the rabbled oil in the reservoir chamber (d);
some millings fo″″) are provided on the side face of the outer upper lid (10) for weight reducing and material economy.

11. Automotive self-adjustable shock absorber with self-correcting damping characteristic, having curved, cylindrical and planar fining valves, according to one of the claims 1 to 10, characterized in that: the outer cylinder (6) is closed in the lower area by a bottom outer lid (12), that inside, in the lower area, has a prominence (k) with the face Q) planar, conically or spherically processed for the location-alignment of the inner cylinder (V), whose lower face (m) is processed in correlation with the face (V) of the prominence (k), lower face (m) of the inner cylinder (V), and/or of the face (V) of the prominence (k), are coated with an easily deformable material 03).

12. Automotive self-adjustable shock absorber with self-correcting damping characteristic, having curved, cylindrical and planar filling valves, according to one of the claims 1 to 11, characterized in that: it has an upper compression planar filling valve (62), formed by an annular plate (63), pressed on the lower face fw′), of the inner cylinder head (7), or on some prominences (i′″), by a spiral, cylindrical or conical spring (64), placed on the inner face (r), of a cup (65% fixed between the upper inner cylinder head (T) and the inner cylinder (V);
the prominences (T″), surround the supply boring (s″″), making one or more enclosures (t″″), connected between them by one or more circular troughs (t′″″);
the borings (s″″) start from the lower face (w5) of the inner cylinder head (T), and they communicate with the holes/milling© carried out in the collar φ of the inner cylinder head (2);
the cup (65) is fixed on the inner cylinder (V), either by pressing/binding, improved with some circular mini-troughs (p″″″), applied on the faces of the fixed parts, or by a circular continuous or discontinuous tab (u″″), carried out in the inner cylinder (V), located on an annular dell/dull (y′″″) of the inner cylinder head (T), or by a safety ring (66), introduced into a trough (z′″″) from the inner cylinder (V), or by prominences (j), fastening hi a trough (k′″″), made in the inner cylinder head (T), or with one or more combinations of these;
it is recommendable that the cup (65) setting on an annular tab (V″″) of the inner cylinder head
(T), placed above the lower face (w′) of the upper inner cylinder head (T);
in the skirt area fw″″) of the cup (65) there are either inner troughs (x″″) or some perforated cuttings/slots (y″″), that perforate the annular area or some outer troughs (z″″), (a′″″), the cuttings being done on the whole height of the cup (65), or they are shorter;
a circular trough (c′″″), carried out in the face (b′″″), outwards, connects the troughs/slots (xT), C£\ddot{υ}, (£D, (ω; at the versions of cutting (xZ\ddot{υ}), (\ddot{ι}\ddot{υ}\ddot{υ}X that do not perforate the face (V″″), the trough (c′″″) is compulsory; at the versions with the troughs (a′″″) that are not applied on the whole length of the cup (65), the skirt area (w″″) stays intact in the setting area on the inner cylinder head (7), forming a continuous collar (d′″″);

13. Automotive self-adjustable shock absorber with self-correcting damping characteristic, having curved, cylindrical and planar filling valves, according to one of the claims 1 to 12, characterized in that: the upper planar valve (62), uses a spring plate (67), with elastic legs (e′″″), right or curved, bent against the plan of the plate, at the lower end the legs (e′″″), have an inflection/rim (f″″), a fillet (g′″″), ensuring the elimination of the concentrators in the are of the legs fixing on the disk (ti″″\ of the plate (67), and a central aperture fi′″″), in the disk (h′″″\ ensures the passing of the piston rod (S);
a disk plate (63), setting on the spring plate (67), increases the pressure resistance;
when the disk plate (63) uses, the spring plate (67) inverted (69) increases the valve sensibility.

14. Automotive self-adjustable shock absorber with self-correcting damping characteristic, having curved, cylindrical and planar filling valves, according to one of the claims 1 to 13, characterized in that: it uses one or more filling valves (68) on the cast annular body, composed of the annular body (74), that is cast from easily fusible materials or injected from resistant plastic material, inside the inner cylinder (Y), or inside the annular cover (43), the annular body (74) containing the filling boring (m′″), the aperture (w′″) for the rivet/screw passing, and some outer prominences the curved/cylindrical/planar plates (33), (35), set directly on the inner curved/cylindrical/planar surfaces (u′″), of the cast annular body (74), or on curved/cylindrical/planar prominences (i), made on the inner surfaces of the cast annular body (74);
the curved/cylindrical/planar plates of the valves (33), (35), are fixed using the previous procedures, shown at the valves on the inner annular body (46), or at the outer valves (31);
the annular body can be continuous or divided into arcs of annular body that include the filling areas, seal-fastening and outer prominences (!′″″), extended from inside the inner cylinder (1)/annular body (43), through the increased filling orifices (iii)/(£D-

15. Automotive self-adjustable shock absorber with self-correcting damping characteristic, having curved, cylindrical and planar filling valves, according to one of the claims 1 to 14, characterized in that: for the filling at rebound it uses one lower planar filling valve (70), formed by the valve body (71), on its upper planar face (n′″″), or on some prominences (i′″), the elastic plate (72) setting, fixed on the valve body (71), by a rivet/screw (34)/(37), passing through the aperture (o′″″). from the plate (72), and through the aperture (p′″″), from the valve body (71);
between the head (ŝ), of the rivet/screw with planar head (37), and the plate (63) and the lower part of the valve body (71) and the lower head (T) of the rivet (34)/(37)/of the nut (38)/(39), there is a planar washer (73);
in the lower area, the valve body (71) has an opening (q′″″) that communicates with the compression compartment (c) through some borings (r′″″) and with the reservoir chamber (d) through some borings/millings (s′″″), carried out in the lower part of the valve body (71);
the prominences (Y″), surrounding the supply borings (r′″″), form one or more enclosures (t″″), connected to one or more circular troughs (f″″), the size of the enclosures (t″″), being correlated with the strength of plates;
the fastening of the valve body QY) is done against the inner cylinder (1) through a tab (u′″″) and against the prominence (k) on the bottom outer lid (12), through an area (V″″) with shapes correlated with (k).

16. Automotive self-adjustable shock absorber with self-correcting damping characteristic, having curved, cylindrical and planar filling valves, according to one of the claims 1 to 14, characterized in that: the upper inner cylinder head (T), has the collar (f), with a smaller diameter than the inside diameter of the outer cylinder (6), so that there is no contact between the two parts, the inner cylinder head Q) and the outer cylinder (6) respectively, an annular enclosure (w′″″) existing between them, the collar (f), having only the part to attenuate the motion of the liquid in the reservoir chamber (d);
a full or annular tab (x′″″), on the upper face of the upper inner cylinder head Q), ensures the cylinder (17) alignment, relative to the upper inner cylinder head Q);

17. Automotive self-adjustable shock absorber with self-correcting damping characteristic, having curved, cylindrical and planar filling valves, according to one of the claims 1 to 16, characterized in that: at the bottom the inner cylinder (1) is closed by the lower inner cylinder head (78), being aligned against it through the tab (u), the lower inner cylinder head (78), being supported and aligned with the surface (v′″″), on the inner tab (k), of the bottom outer lid (12) of the outer cylinder (6).

18. Automotive self-adjustable shock absorber with self-correcting damping characteristic, having curved, cylindrical and planar filling valves, according to one of the claims 1 to 17, characterized in that: the inner cylinder Q), is lengthened at the top above the inner cylinder head Q), at the level of the upper outer upper lid (10), being fixed/centered in its tab (f), taking over the function of the cylinder (17), too, that is the formation of the balance chamber (h), for this purpose it contains the orifices (g), for the circulation of the liquid and some disks (18) provided with the communication orifices (ĝ);
the disks (18) are fixed inside and/or outside the cylinder Q), either rigidly by pressing or welding, or by shape, for the press fastening it is recommendable that the disk to be provided with a collar (h/) with some orifices (T), or channels/slots (iθ, in order to favor the cupping, for the fastening by shape on the cylinder Q) there are provided some troughs or hollows (k), where the prominences (Y) preferably inclined in the pre-ultimate area (m′), are fixed elastically or by molding, if there are several disks (18) two or more of them can be coupled through connecting links (nθ provided with orifices (oj) for oil passing;
the inner cylinder head Q), has its diameter correlated with the inner diameter of the inner cylinder Q), in order to enter by pressing, the fastening of the inner cylinder head (7) in the inner cylinder Q), is done either by pressing/binding favored by some fine circular troughs (s″″) in the inner cylinder head (T) and the inner cylinder (Y), or by one or more circular continuous or discontinuous tabs (u″″), carried out in the inner cylinder (1), located on an annular dell/dull (y′″″) of the inner cylinder head (T), or by the safety rings (66), introduced in the troughs (z′″″) from the inner cylinder (Y);
when the upper inner cylinder head (T), plays also the role of the valves body (70), containing the borings (swy), the inner cylinder (Y) will have orifices (o″″″), corresponding to the borings (a-

19. Automotive self-adjustable shock absorber with self-correcting damping characteristic, having curved, cylindrical and planar filling valves, according to one of the claims 1 to 18, characterized in that: the piston (4), has central aperture (g£), for the piston rod (5) passing, the aperture being conical in the lower area (c″″″), an area where the head (bmm\ formed by the flanging/molding of the lower extremity of the piston rod (5), fixes the piston;
it is recommendable that the indentations (f′″″), on the mould head be horizontal or inclined to avoid the building up of the gas pocket, for this purpose, their level being under the level of the lower face (cT), of the piston (4).

20. Automotive self-adjustable shock absorber with self-correcting damping characteristic, having curved, cylindrical and planar filling valves, according to one of the claims 1 to 19, characterized in that: the piston (4), at the bottom has a cutting fa″″″), where there is the flanged head (b″″″), formed by the flanging/molding of the lower extremity of the piston rod (5), the head (b″″″), fixing the piston (4), on the piston rod (5), either directly when for favor the molding, the aperture (ĝ), for the piston rod (5) passing, is conical at the bottom (c\ddot{υ}\ddot{υ}\ddot{υ}), or indirectly through a washer (75), that has the conical area (e″″w) in the aperture (\acute{α}mm\ for passing the piston rod, in order to favor the cupping;
the cutting (a″″″), is closed by a lid (29), setting on the bottom of the cutting (a″″″), on the washer (75) respectively, so that the lower face (f″″″), of the lid (29), be under the lower face (cT) of the piston (4).

21. Automotive self-adjustable shock absorber with self-correcting damping characteristic, having curved, cylindrical and planar filling valves, according to one of the claims 1 to 20, characterized in that: the piston (4), at the bottom has a cutting (a″″″), closed at the bottom by a Hd (76), provided at the top with an annular tab (g″″″), ensuring the radial alignment against the cutting (a″″″) and the axial fastening through support on the lower face (cT) of the piston (4);
the lid (76), is provided with a central opening (h″″″), through which the piston rod (5) passes, against which it is radial aligned;
the flange head (b″″″), formed by the flanging of the lower extremity of the piston rod (5), fixes the assembly piston (4)-lid (76), between the tab (c£) of the rod (5), to favor the flanging of the head (b″″″\ the boring (h″″″\ is conical at the bottom (i″″″);
it is recommendable that the indentations (j), on the cupping head be horizontal or inclined to avoid the building up of the gas pocket, for this purpose, their level being under the level of the lower face (cT), of the piston (4).

22. Automotive self-adjustable shock absorber with self-correcting damping characteristic, having curved, cylindrical and planar filling valves, according to one of the claims 1 to 21, characterized in that: the removable gasket (57), is fixed directly in the inner cylinder (V), at its upper extremity, that is provided with some circular troughs (m″″″), with the desired section, where the circular prominences (P″) enter. For a more secure fastening it is recommendable to use a safety ring Q)5 fixed in the trough (x″″″\ the fastening/alignment of the inner cylinder (V), relative to the outer cylinder (6), is done at the upper area through the annular lid (T), with “L”-shaped section, the vertical crown (g) ensuring the radial fastening relative to the inner processed/unprocessed surface (g) of the outer cylinder (6), and the horizontal crown (r) ensuring the axial fastening relative to the edge of closing (s), of the outer cylinder (6).

23. Automotive self-adjustable shock absorber with self-correcting damping characteristic, having curved, cylindrical and planar filling valves, according to one of the claims 1 to 22, characterized in that: the fastening/alignment of the inner cylinder (V), relative to the outer cylinder (6), is done at the bottom through the annular tab (n′*″″), carried out in the bottom outer lid (12), annular tab (n″″″) aligned relative to the inner processed/or not processed surface (p_), of the outer cylinder (C).

24. Automotive self-adjustable shock absorber with self-correcting damping characteristic, having curved, cylindrical and planar filling valves, according to one of the claims 1 to 23, characterized in that: the fastening/alignment of the inner cylinder (V), relative to the outer cylinder (6), is done at the upper area, axially through the edge(s) and radial through the longitudinal indentations (q″″″), or the annular tab (r\ that have the inner faces (s″″″) processed in order to adjust rigidly with the inner cylinder (V);
the longitudinal indentations (q″″″)? can be prolonged downwards for reinforcing and improvement of the cooling when their inner faces (s″″″) are partially processed or on the whole surface, for reinforcing.

25. Automotive self-adjustable shock absorber with self-correcting damping characteristic, having curved, cylindrical and planar filling valves, according to one of the claims 1 to 24, characterized in that: it uses a curved filling valve, with rigid/semi rigid/elastic plates, with outer spring plate, composed of a curved/cylindrical/planar, rigid/semi rigid/elastic plate (51)/(33), placed inside the inner cylinder (V), or inside the inner annular body (47), or annular cover (43), or the injected/cast cover (74), directly or on the prominences (i′″), obstructing the orifices for the oil penetration (£), (f̂);
the plate (51)/(33), is fixed on the rivet/screw (53) through the orifice (z′″), both of them having rectangular or oval or other section, in order to avoid the rotation;
the rivet/screw (53) slides in the boring (y″″″), from inner cylinder (1)/annular cover (43)/annular body (47)/cast/injected annular body (74), controlled by the spring plate (77), fixed at its extremity by riveting or nut;
in order to permit the access of the liquid, the arms of the spring have borings/slots fi′″).
